(19) United States
(12) Patent Application Publication
(10) Pub. No.: US 2005/0265725 A1
(43) Pub. Date: Dec. 1, 2005

(54) Optical transmission apparatus, optical transmission system and dispersion compensating method

(75) Inventors: Satoru Okano, Yokohama (JP); Motoyoshi Sekiya, Kawasaki (JP); Kaori Odate, Tokyo (JP); Tatsuru Iwaoka, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/954,310

(22) Filed: Oct. 1, 2004

(30) Foreign Application Priority Data
May 28, 2004 (JP) 2004-159668

(51) Int. Cl. H04B 10/12

(52) U.S. Cl. 398/147

(57) ABSTRACT

In a long-distance and large-capacity optical transmission system, a dispersion compensating device showing a wavelength-dependency of dispersion characteristic is provided in a transmission line which makes a connection between a transmission terminal node and a reception terminal node. The reception terminal node acquires a dispersion quantity relative to single-wavelength light outputted from a wavelength-variable transmitter which is provided in the transmission terminal node for outputting single-wavelength light, and transmits wavelength control information corresponding to the acquired dispersion quantity to the transmission terminal node. The transmission terminal node varies the wavelength of the transmitter on the basis of the transmitted wavelength control information. This enables acquiring an optimum dispersion compensation quantity with a simple configuration and optimizing a dispersion compensation quantity for each channel at the transmission of wavelength-multiplexed light.

### BACKGROUND OF THE INVENTION

(1) Field of the Invention

The present invention relates to an optical transmission apparatus, an optical transmission system and a dispersion compensating method, suitable for the dispersion compensation (chromatic dispersion) for an optical transmission apparatus and its peripheral units in an optical transmission system.

In general, an optical transmission system requires enhancing the transmission data capacity and lengthening the transmission distance. The capacity enhancement depends on an increase in data transmission rate and the employment of a wavelength division multiplexing method (WDM) method.

In a WDM transmission system (WDM optical transmission system), for further capacity enhancement, there has been studied a method of increasing the number of wavelengths by enlarging a WDM light transmission band and a method of increasing the number of wavelengths by making the densification of wavelength spacing in a WDM light transmission band. The enlargement of the transmission band is limited by an amplification characteristic of an optical fiber amplifier or the like, while the densification of the wavelength spacing is affected by the interference between signal lights with different wavelengths and the non-linear optical effects. For this reason, along with the enhancement of the transmission capacity, difficulty is experienced in lengthening the transmission distance, for that the waveform distortion of signal light occurs.

Meanwhile, as called group velocity dispersion (GVD), the chromatic dispersion occurs because, when a signal light is transmitted through an optical fiber transmission line, the group velocity varies according to a wavelength component of a transmission wavelength, which causes a waveform degradation at a reception end portion.

FIG. 27A is an illustration of one example of dispersion characteristic of an optical fiber. As shown in FIG. 27A, the values of dispersion characteristic curves (curves indicative of dispersion characteristics through the use of a coefficient of dispersion) C1 and C2 respectively increase and decrease as the wavelength λ becomes longer, and the optical fiber characteristic denoted by these dispersion characteristic curves C1 and C2 varies according to an optical fiber maker, the environment of a transmission line or the like. Moreover, the value (gradient of the dispersion characteristic curve C1, C2) obtained by differentiating the dispersion characteristic with respect to the wavelength λ is referred to as a dispersion slope, and this dispersion slope is also a factor of waveform degradation.

FIG. 27B is an illustration of one example of dispersion slope characteristic. An important point for the improvement of transmission quality of the WDM transmission system is how to compensate for the dispersion in a transmission line and the dispersion slope.

On the other hand, the non-linear optical effect arises due to a variation of a transmission medium such as an optical fiber according to a signal light intensity and principally includes the self phase modulation (SPM), the cross phase modulation (XPM), the four wave mixing (FWM), and others. This self phase modulation is a phase modulation of a signal light occurring due to an intensity variation of the signal light itself, and the cross phase modulation is a phase modulation of a signal light occurring due to an intensity variation of a signal light with a different wavelength, while the four wave mixing signifies that lights with wavelengths corresponding to the wavelength sum of single-wavelength (monochromatic) lights and the wavelength difference therebetween are produced so as to affect different signal lights.

So far, for the longer transmission distance, the improvement of the transmission quality has been made by, for example, employing an optical amplifier and a Raman amplifier or by employing an error correction function (FEC [Forward Error Correction]). The employment of the optical amplifier and the Raman amplifier makes the reception side call OSNR (Optical Signal Noise Ratio) better and improves values related to the quality, such as BER (Bit Error Rate: error rate) and Q (Quality)-value, while the employment of the error correction function improves the quality with respect to the call OSNR.

For example, as the optical amplifier, a post-amplifier for enhancing the transmission power (transmission strength) to a higher power, a pre-amplifier for sensitizing the reception power, an inline amplifier (repeater) provided in a transmission line for amplifying and repeating a wavelength-multiplexed light (wavelength-multiplexed light produced by multiplexing a plurality of single-wavelength lights different in wavelength from each other, and others, have diversely been developed and manufactured, thereby lengthening the transmission distance rapidly. Moreover, the Raman amplifier takes advantage of the phenomenon that, when an excitation light is supplied to a transmission line, a gain develops on an approximately 100-nm long-wavelength side, for example, in 1.5-μm band with respect to the excitation light wavelength and makes the transmission line itself function as an amplification medium, thus preventing the signal light intensity from lowering.

Furthermore, with respect to the capacity enhancement, a study has been made on the increase in transmission rate and the densification of wavelength spacing. For the increase in transmission rate, an optical transmission apparatus serving as a terminal node (terminal station) having a transmission rate (bit rate after optical-electrical conversion) of 10 Gb/s (giga bit per second) has already been put into practical use, and research/development is being made on an optical transmission apparatus having a higher transmission rate. Moreover, with respect to the wavelength spacing densification, a WDM optical transmission apparatus has been commercialized which is capable of realize the multiplexing of single-wavelength lights more than 100 waves, and research/development is being made on further wavelength spacing densification.

Unless otherwise specified particularly, the optical transmission apparatus signifies a terminal node, a repeating node and an OADM (Optical Add and Drop Multiplexer) node.

Moreover, as the network configuration in the WDM transmission system, there are various configurations including a TERM-Term (transmission terminal node-reception terminal node) type, a hub type and a ring type, and a high-quality WDM transmission becomes necessary irrespective of these configurations.

A large number of techniques have been proposed with respect to the WDM transmission modes, and a method has been proposed which controls the dispersion quantity by adjusting a wavelength-variable light source of a transmitter (for example, see Patent Documents 1 and 2).

The optical transmission system disclosed in Patent Document 1 is designed to measure a transmission characteristic to carry out the control of signal light wavelength in a wavelength-variable light source, the control of prechirping quantity, the control of dispersion compensation quantity and the control of optical power for the best transmission characteristic, thereby optimizing the transmission condition.

Moreover, the dispersion control method disclosed in Patent Document 2 is designed to make a comparison in phase between a low-frequency component of a signal light extracted through a band pass filter and a low-frequency signal outputted from an oscillator to automatically control the dispersion compensation quantity in accordance with the comparison result. This enables monitoring and controlling the transmission line dispersion with respect to an optical signal in which its clock component reaches a minimum at the zero-dispersion, thus achieving the control of the transmission line dispersion without interrupting the system operation.

Incidentally, as one example of a dispersion compensating device, there has been proposed an (Ripple-free) optical band filter simple in design and free from ripple (for example, see the Non-Patent Document 1).

Patent Document 1

Japanese Patent Laid-Open No. HEI 8-321805

Patent Document 2

Japanese Patent Laid-Open No. HEI 11-68657

Non-Patent Document 1

Benjamin B. Dingel, Tadashi Aruga, “properties of a Novel Noncascaded Type, Easy-to-Design, Ripple-Free Optical Band Pass Filter”, Journal of lightwave technology, vol. 17, NO. 8, August 1999

As mentioned above, in the case of the fast optical transmission exceeding 10 Gb/s, the waveform distortion appears noticeably due to SPM, dispersion and others and, for example, BER rapidly degrades. For this reason, the dispersion compensation using a dispersion compensating device such as a dispersion compensating fiber (DCF) or fiber grating becomes essential. In particular, for a transmission rate exceeding 40 Gb/s, without the dispersion compensation, difficulty is encountered in achieving the long-distance and/or high-quality optical transmission.

In addition, in the WDM transmission system, a common dispersion compensating device such as DCF compensates, in the block, for the dispersion in a specific wavelength band. At this time, a dispersion slope exists for making a compensation inclusive of the wavelength dependency of the dispersion occurring in a transmission line. However, there is a problem in that it is far from easy to carry out the optimum dispersion compensation inclusive of the wavelength dependency with respect to all the wavelengths for use in a WDM transmission system.

In addition, each of the dispersion characteristic and dispersion slope characteristic of an actual transmission line has fluctuations, and each data such as transmission line dispersion quantity or dispersion compensation quantity calculated at the design of the WDM transmission system is not always the optimum data at the actual operations In particular, in the case of a transmission rate of 40 Gb/s, since the dispersion strength (residual dispersion tolerance) at a reception portion is extremely small (for example, approximately 60 ps/nm), the transmission can become impossible even if a minute error appears with respect to a design value of an actual transmission line.

In this case, there is a need to measure the dispersion value of the transmission line for adjusting the dispersion compensation quantity to the optimum value and this requires, for example, the replacement of a dispersion compensator, which produces a large demerit in terms of cost and time. As well as the 40-Gb/s transmission, a 10-Gb/s long-distance transmission also creates this problem.

Moreover, since a long-distance and a large-capacity optical transmission system requires high-accuracy dispersion compensation as mentioned above, a problem arises in that there is a need to prepare a large number of dispersion compensator menus (for example, DCF's types having different dispersion compensation quantities and different dispersion slopes) in conjunction with types of transmission line or transmission distances (or dispersion value).

### SUMMARY OF THE INVENTION

The present invention has been developed in consideration of these problems, and it is therefore an object of the invention to provide, in a long-distance and large-capacity optical transmission system, an optical transmission apparatus, an optical transmission system and a dispersion compensating method, which are capable of obtaining an optimum dispersion compensation quantity through the use of a simple configuration.

For this purpose, in accordance with an aspect of the present invention, there is provided an optical transmission apparatus for use in an optical transmission system, comprising a dispersion compensating device having a wavelength-dependency dispersion characteristic for compensating for dispersion of transmitted light and a wavelength-variable (tunable) transmission unit for transmitting light whose center emission wavelength is shifted by a wavelength fluctuation (change) quantity relative to the dispersion characteristic of the dispersion compensating device.

Thus, also in an optical transmission system equipped with a dispersion compensator having a fixed dispersion compensation quantity, the dispersion compensation quantity is adjustable in a predetermined range through the use of a simple configuration.

Furthermore, in accordance with another aspect of the present invention, there is provided an optical transmission apparatus comprising a plurality of transmission units different in center emission wavelength from each other, a dispersion compensating device having a dispersion characteristic which develops repeatedly with respect to a wavelength in a predetermined wavelength band, and a wavelength control unit for controlling the center emission wavelengths of the transmission units on the basis of transmission performance information measured on a reception side.

This enables feedback-controlling a wavelength of a signal light through the use of a sub-signal light (for example, OSC [Optical Supervisor Channel]), thereby achieving the automatic adjustment on the dispersion compensation quantity.

Still furthermore, in accordance with a further aspect of the present invention, there is provided an optical transmission system comprising a plurality of optical transmission apparatus, a dispersion compensating device having a wavelength-dependency dispersion characteristic for compensating for dispersion of transmitted light, and a wavelength-variable transmission unit for transmitting light whose center emission wavelength is shifted by only a wavelength fluctuation quantity relative to the dispersion characteristic of the dispersion compensating device.

Thus, as one example, the adjustment to the optimum dispersion compensation quantity can be made by controlling the transmission wavelength of a transmission terminal node on the basis of measured dispersion quantity data on an actual dispersion quantity measured or calculated by a reception terminal node or transmission performance information such as BER (Bit Error Rate) or error correction frequency (number of times of error correction), which enables dynamic and automatic adjustment.

Moreover, the optical transmission apparatus according to the present invention can optimize the dispersion compensation quantity for each channel in the WDM transmission system, and can optimize the dispersion compensation quantity for each of add, drop and through channels in a system configuration including an optical add/drop node.

In addition, in accordance with a further aspect of the present invention, there is provided a dispersion compensating method for use in an optical transmission system equipped with a plurality of optical transmission apparatus each including a transmitting-side optical transmission unit and a receiving-side optical transmission unit, comprising a dispersion quantity acquiring step in which the receiving-side optical transmission unit acquires a dispersion quantity with respect to first single-wavelength light outputted from a wavelength-variable transmission unit provided in the transmitting-side optical transmission unit for outputting single-wavelength light, a transmission step in which the receiving-side optical transmission unit transmits, to the transmitting-side optical transmission unit, wavelength control information relative to the dispersion quantity acquired in the dispersion quantity acquiring step, and a fluctuation step in which the transmitting-side optical transmission unit fluctuates a wavelength of the transmission unit on the basis of the wavelength control information transmitted in the transmission step.

This enables fast transmission and the dispersion compensation on an individual transmission path and further considerably improving the work efficiency about the installation and maintenance, thus adjusting the dispersion compensation quantity in units of wavelength of each single-wavelength light.

Moreover, this can remove the waveform distortion and promote the practical application of the long-distance transmission.

In addition, in this case, it is also appropriate that the transmission unit is made to vary a wavelength of single-wavelength light on the basis of a dispersion slope of the dispersion compensating device, and that the transmission unit is made to output single-wavelength light having a wavelength which is obtained by shifting the shortest wavelength in a wavelength-multiplexed light transmission band to a long-wavelength side and to transmit single-wavelength light having a wavelength which is obtained by shifting the longest wavelength in the wavelength-multiplexed light transmission band to a short-wavelength side.

Still additionally, it is also appropriate that the optical transmission apparatus further comprises a wavelength control unit for controlling a wavelength fluctuation quantity on the basis of wavelength control information relative to a dispersion quantity which is acquired in the reception side.

Yet additionally, the wavelength control unit can be designed to control the wavelength fluctuation quantity on the basis of wavelength control information feedbacked through a transmission line of the optical transmission system, and it can be designed to control the wavelength fluctuation quantity on the basis of an actual dispersion quantity of the transmission line of the optical transmission system, and it can be designed to control the wavelength fluctuation quantity on the basis of transmission performance information from a monitoring unit which is made to acquire information on a transmission performance of the optical transmission system.

Furthermore, the dispersion compensating device can be designed as a demultiplexing unit made to demultiplex wavelength-multiplexed light, and it can be designed as a multiplexer made to multiplex a plurality of single-wavelength lights, and it can be designed as a combination of a demultiplexing unit for demultiplexing wavelength-multiplexed light and a multiplexer for multiplexing a plurality of single-wavelength lights.

This enables optimizing the dispersion compensation quantity for each channel in the WDM transmission system and optimizing the dispersion compensation quantity for each of add, drop and through channel in a system configuration including an optical add/drop node.

Still furthermore, in the aforesaid optical transmission system, it is also appropriate that the transmitting-side optical transmission unit includes a wavelength-variable transmission unit for outputting one of a plurality of single-wavelength lights different in wavelength from each other.

Yet furthermore, it is also appropriate that the aforesaid optical transmission system further comprises a wavelength control unit for controlling the wavelength fluctuation quantity on the basis of wavelength control information relative to a dispersion quantity acquired in one of the plurality of optical transmission apparatus.

Moreover, it is also appropriate that the wavelength control unit receives at least one of dispersion quantity information and transmission performance information included in the wavelength control information through the use of one of sub-signal light transmitted from the reception side to the transmission side, monitor control means for monitoring and controlling the plurality of optical transmission apparatus and main signal light transmitted from the reception side to the transmission side.

Still moreover, it is also possible that the dispersion compensating device has a total dispersion characteristic based on a dispersion characteristic of a multiplexer or a demultiplexer provided in a transmission line.

Yet moreover, it is also possible that the dispersion compensation is made through the use of a plurality of dispersion compensator menus in which a dispersion compensation quantity relative to a wavelength fluctuation quantity in the transmission unit and the dispersion compensating device are associated with each other.

This enables optimally adjusting the dispersion compensation quantity through the use of a simple configuration, which can achieve the cost reduction.

It is also appropriate that, in the transmission step, the receiving-side optical transmission unit transmits the wavelength control information including at least one of the dispersion quantity information and the transmission performance information to the transmitting-side optical transmission unit.

Thus, since the wavelength in the transmission unit can be adjusted to adjust the dispersion compensation quantity, the dispersion compensation quantity of, for example, a DCF (dispersion compensating device) or the like can be optimized promptly without replacing a fixed dispersion compensating device.

### BRIEF DESCRIPTION OF THE DRAWINGS

FIG. 1 is an illustration of one example of a dispersion characteristic of a dispersion compensating device to which the present invention is applied, for explaining a basic operation of the present invention;

FIG. 2 is an illustration of one example of a dispersion characteristic of an etalon filter;

FIG. 3 is an illustration useful for explaining operations and effects of the present invention in a case in which an optical transmission system is configured by a combination of the dispersion compensating device shown in FIG. 2 and a common dispersion compensator;

FIG. 4 is an illustration useful for explaining effects of the present invention;

FIG. 5 is an illustration useful for explaining a dispersion compensating method for use in an optical transmission system according to a first embodiment of the present invention;

FIG. 6 is an illustration of an example of a configuration of a WDM transmission system according to a second embodiment of the present invention;

FIG. 7 is an illustration of one example of an oscillation characteristic of a tunable laser diode;

FIGS. 8A and 8B are illustrations useful for explaining the effects of a case in which the present invention is applied to a WDM transmission system, on the basis of a dispersion map indicative of a dispersion quantity with respect to a transmission distance;

FIGS. 9A and 9B are illustrations useful for explaining the effects of a case in which the present invention is applied to a WDM transmission system, on the basis of a dispersion quantity with respect to a wavelength;

FIG. 10 is an illustration of an example of a configuration of a WDM transmission system according to a third embodiment of the present invention;

FIG. 11A is an illustration of one example of a transmission characteristic of a multiplexer;

FIG. 11B is an illustration of one example of a dispersion characteristic in the case of a combination of a multiplexer and a demultiplexer;

FIG. 12A is an illustration of an arrangement of a demultiplexer using an etalon type interleaver according to the third embodiment of the present invention;

FIG. 12B is an illustration useful for explaining the interleaver according to the third embodiment of the present invention;

FIG. 13A is an illustration of a transmission characteristic and dispersion characteristic of an odd channel according to the third embodiment of the present invention;

FIG. 13B is an illustration of a transmission characteristic and dispersion characteristic of an even channel according to the third embodiment of the present invention;

FIG. 13C is an illustration of transmission characteristics and dispersion characteristics of all of channels according to the third embodiment of the present invention;

FIG. 14 is an illustration of an example of a configuration of an optical transmission system according to a first modification of the third embodiment of the present invention;

FIG. 15 is an illustration of a configuration of a WDM transmission system according to the first modification of the third embodiment of the present invention;

FIG. 16 is a flow chart useful for explaining a dispersion value automatic measurement and transmission wavelength control according to the first modification of the third embodiment of the present invention;

FIG. 17 is an illustration of a configuration of a WDM transmission system according to a second modification of the third embodiment of the present invention;

FIG. 18 is an illustration of a configuration of a WDM transmission system according to the second modification of the third embodiment of the present invention;

FIG. 19 is a block diagram showing a transmission performance information acquiring unit according to the second modification of the third embodiment of the present invention;

FIG. 20 is an illustration of a configuration of a WDM transmission system according to a third modification of the third embodiment of the present invention;

FIG. 21 is an illustration useful for explaining feedback control according to the third modification of the third embodiment of the present invention;

FIG. 22 is an illustration useful for explaining another feedback control according to the third modification of the third embodiment of the present invention;

FIG. 23 is a flow chart useful for explaining transmission wavelength control according to the third modification of the third embodiment of the present invention;

FIG. 24 is an illustration of a configuration of a WDM transmission system according to a fourth embodiment of the present invention;

FIG. 25A is an illustration of one example of residual dispersion according to the fourth embodiment of the present invention;

FIG. 25B is an illustration useful for explaining a residual dispersion adjusting method according to the fourth embodiment of the present invention;

FIG. 26A is an illustration of one example of a conventional dispersion compensator menu;

FIG. 26B is an illustration of one example of a dispersion compensator menu according to the first embodiment of the present invention;

FIG. 27A is an illustration of one example of a dispersion characteristic of an optical fiber; and

FIG. 27B is an illustration of one example of a dispersion slope characteristic.

### DESCRIPTION OF THE PREFERRED EMBODIMENTS

(A) Description of Basic Operation of the Present Invention

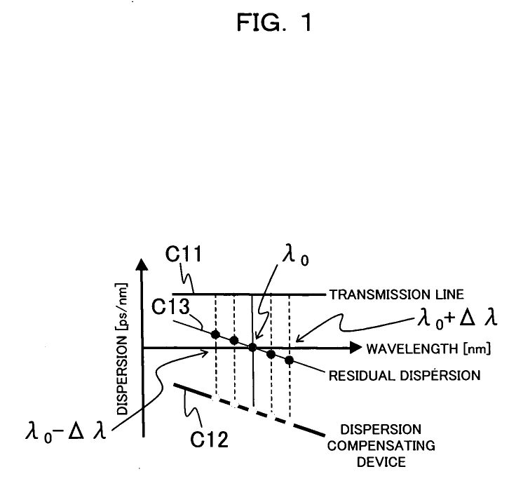

FIG. 1 is an illustration of one example of a dispersion characteristic of a dispersion compensating device to which the present invention is applied, for explaining a basic operation of the present invention. In FIG. 1, λ₀ designates a center wavelength of an optical signal to be transmitted, and the horizontal axis represents a wavelength in the vicinity of this center wavelength while the vertical axis denotes a dispersion quantity. The dispersion compensating device is an etalon filter, which will be mentioned later, or the like having a wavelength-dependency dispersion characteristic.

In the illustration, C11 depicts a dispersion quantity in an optical transmission line, and the dispersion quantity relative to the wavelength is almost constant in a narrow wavelength band in the vicinity of λ₀.

Moreover, C12 indicates a dispersion characteristic of the dispersion compensating device, with the dispersion quantity increasing on the short-wavelength side with respect to of λ₀ in a wavelength band in the vicinity of λ₀ and it decreasing on the long-wavelength side.

For example, in a case in which the dispersion compensating device has a dispersion slope of 1000 ps/nm², if the center wavelength of the optical signal to be transmitted fluctuates by ±0.1 nm (λ₀±Δλ), the fluctuation width of the dispersion quantity of the dispersion compensating device becomes ±100 ps/nm.

Still moreover, C13 designates a residual dispersion of an optical transmission system which is the sum of the aforesaid dispersion quantity of the transmission line and the dispersion quantity of the dispersion compensating device.

This signifies that the residual dispersion quantity is adjustable in accordance with the dispersion slope of the dispersion compensating device by changing the center wavelength of an optical signal to be transmitted and, in the above-mentioned example, the residual dispersion is adjustable by ±100 ps/nm by varying the center wavelength by ±0.1 nm.

As one example of a dispersion compensating device having the above-mentioned dispersion characteristic, there is an etalon filter.

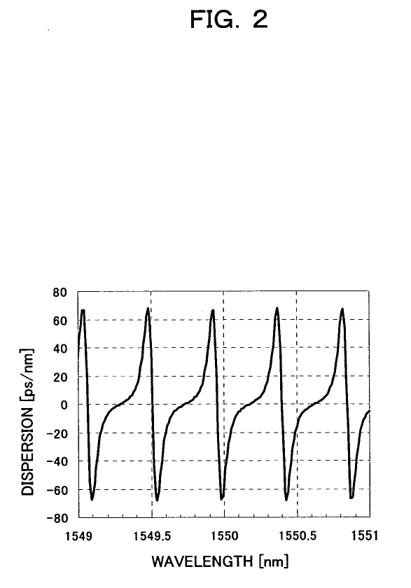

FIG. 2 is an illustration of one example of a dispersion characteristic of an etalon filter. In the dispersion characteristic shown in FIG. 2, for example, the dispersion quantity varies from approximately +68 ps/nm to −68 ps/nm in a wavelength band with a width of approximately 0.1 nm in the vicinity of 1549.5 nm. That is, when the wavelength is changed by approximately 0.1 nm, the dispersion quantity can vary by approximately 140 nm.

In addition, since, in this etalon filter, the dispersion characteristic has a periodicity relative to the wavelength, it is applicable to a plurality of wavelengths (for example, ITU [International Telecommunication Union] grid) for use in a WDM transmission system. In this case, the ITU grid (ITU-T wavelength grid) prescribes each wavelength (frequency) constituting a WDM standardized by ITU.

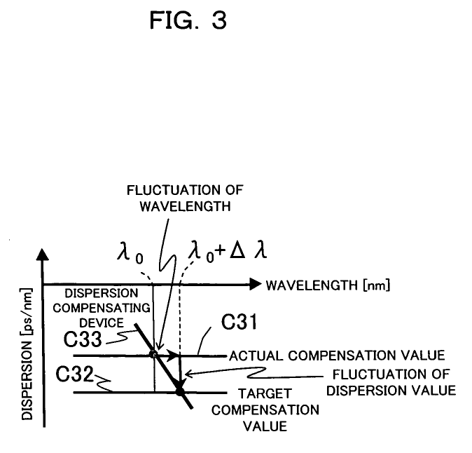

FIG. 3 is an illustration useful for explaining operations and effects of the present invention, and shows an example in which an optical transmission system is constructed by a combination of a dispersion compensating device (for example, an etalon filter having the characteristic shown in FIG. 2) and a common dispersion compensator, for example, a DCF.

In FIG. 3, the vertical axis represents a dispersion compensation value (dispersion compensation quantity), and λ₀ depicts a center wavelength of an optical signal to be transmitted. Moreover, in FIG. 3, C31 denotes a dispersion compensation value of a general dispersion compensator, for example, a DCF, C32 depicts a target (desired) dispersion compensation value. According to a conventional technique, for acquiring a target dispersion compensation value, there is a need to replace, for example, a DCF.

Still moreover, C33 indicates a dispersion compensation characteristic of the dispersion compensating device shown in FIG. 1. As shown in FIG. 3, when the center wavelength of an optical signal to be transmitted is changed from λ₀ to λ₀+Δλ, the dispersion compensation value also varies in accordance with the wavelength dependency of the dispersion value of the dispersion compensating device so that a target dispersion compensation value is obtainable.

Thus, a combination of the dispersion compensating device shown in FIG. 1 and a common dispersion compensator, for example, a DCF, fulfills a function as a variable dispersion compensator having an offset corresponding to the dispersion value of the DCF.

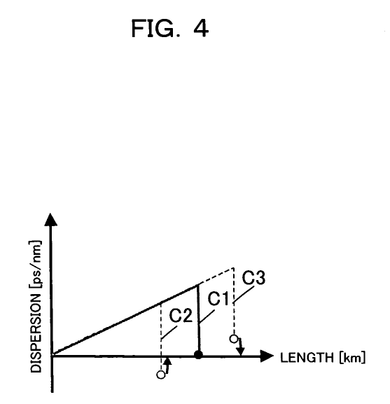

FIG. 4 is an illustration useful for explaining the effects of the present invention. A dispersion map expressed by a dispersion characteristic curve C1 shown in FIG. 4 is made out at the design of the optical transmission system. Moreover, FIG. 4 is one under an assumption that this dispersion map is based on the employment of a common dispersion compensator, for example, a DCF. Still moreover, in a case in which the actual transmission distance (optical fiber cable length) is shorter or longer than designed, a dispersion map represented by a dispersion characteristic curve C2 or C3 is produced as shown in FIG. 4, and the dispersion quantity goes to excess or comes short. At this time, if the center wavelength of light to be transmitted is properly changed according to the present invention, the dispersion compensation quantity varies in accordance with the wavelength dependency of the dispersion quantity of the dispersion compensating device, thus enabling the adjustment to the optimum residual dispersion quantity without replacing it with a DCF capable of providing the optimum dispersion compensation quantity. That is, on C2 and C3 in FIG. 4, the values of the white circle portions indicative of the residual dispersion quantities in the case of no employment of the present invention are adjustable to the optimum residual dispersion quantity.

Embodiments of the present invention will be described hereinbelow with reference to the drawings.

Although in the description of the present invention each end node having an optical-electrical conversion unit or an electrical-optical conversion unit is referred to as a terminal node, even if the present invention is applied to an REG (3R [Retiming, REGenerating, Reshaping] regenerative repeating) node, similar effects are attainable. Moreover, although in general each end node is equipped with an optical transmission function unit and an optical reception function unit, for convenience in explanation only, in each illustration, the left side is referred to as a transmission node while the right side is referred to as a reception node.

In addition, the direction from the transmission node to the reception node is referred to as a down-direction while the direction from the reception node to the transmission node is referred to as an up-direction.

(B) Description of First Embodiment of the Present invention

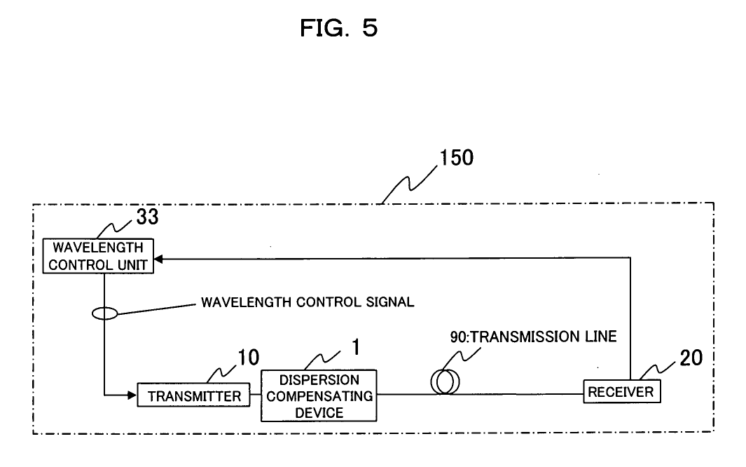

FIG. 5 is an illustration useful for explaining a dispersion compensating method for use in an optical transmission system according to a first embodiment of the present invention. In FIG. 5, an optical transmission system 150 is made up of a transmitter (transmission unit) 10, a dispersion compensating device 1, a transmission line 90, a receiver (reception unit) 20, and a wavelength control unit 33.

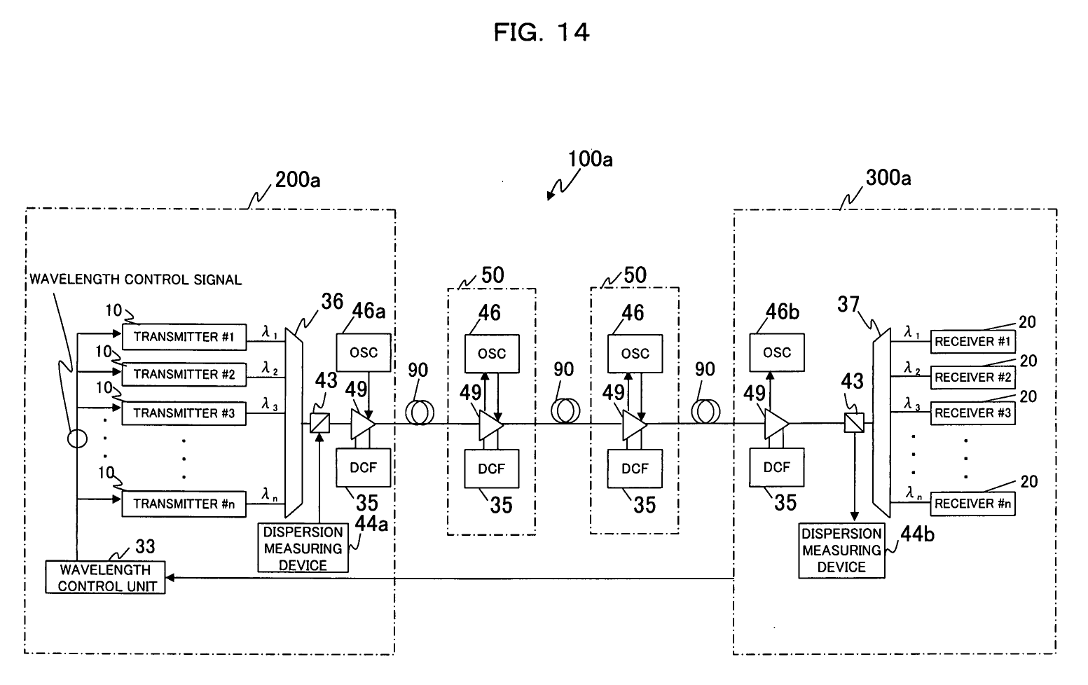

In this configuration, the transmitter 10 is of a wavelength-variable (tunable) type which transmits light whose center emission wavelength is shifted by a wavelength fluctuation quantity relative to a dispersion characteristic of the dispersion compensating device 1. Concretely, the transmitter 10 is made to transmit light (for example, any single-wavelength light) and is made such that the center emission wavelength of the light to be transmitted is variable under control from the external. For example, it includes a tunable laser diode. The transmission line 90 is an optical fiber transmission line and, for example, an inline amplifier (see FIG. 14 and others, which will be mentioned later) can be provided therein as needed. The receiver 20 is made to receive a signal light transmitted from the transmitter 10 through the transmission line 90.

In addition, this transmitter 10 is designed to change the wavelength of a single-wavelength light on the basis of a dispersion slope of the dispersion compensating device 1.

The dispersion compensating device 1 has a wavelength-dependency dispersion characteristic and is for compensating for the dispersion of a transmitted light. It has the dispersion characteristic shown in FIG. 1, and is realizable with the aforesaid etalon filter or the like. Incidentally, the dispersion compensating device 1 can be provided on the transmission side or the reception side in accordance with various conditions which are represented by transmission line length, transmission line type and others and determine a system (system specification), or it can be placed on both the sides, and it can also be used in a state combined with other dispersion compensator, for example, a DCF.

Furthermore, the wavelength control unit 33 is for controlling the wavelength fluctuation quantity of the transmitter 10 on the basis of wavelength control information corresponding to a dispersion quantity, acquired through measurement, calculation or the like in the reception side (for example, receiver 20). Concretely, the wavelength control unit 33 controls the center emission wavelength of the transmitter 10 on the basis of transmission performance information from a monitor unit made to acquire information related to a transmission performance of the optical transmission system 150.

Thus, the transmitter 10 functions as a transmission unit to output a single-wavelength light having a wavelength obtained by shifting the wavelength of a single-wavelength light by a quantity corresponding to a predetermined wavelength on the basis of the dispersion characteristic of the dispersion compensating device 1.

As acceptable methods of transferring information (actual dispersion quantity information and transmission performance information) from the receiver 20 to the wavelength control unit 33, there are a method of transferring it in a state included in an OSC light going from the reception side to the transmission side, a method in which the receiver 20 transfers that information to the transmission side after once passing through a monitor control apparatus (not shown) which is made to carry out the monitor control on the entire system, a method of transferring it in a state included in a main signal from the reception side to the transmission side, and other methods.

That is, the wavelength control unit 33 is made to receive, as a wavelength fluctuation quantity, one of or both the dispersion quantity information and the transmission performance information, included in the wavelength control information, through the use of the OSC light transmitted from the reception side to the transmission side, and it is made to control the wavelength fluctuation quantity on the basis of the actual dispersion quantity of the transmission line 90 of the optical transmission system 150.

In other words, the wavelength control unit 33 controls the wavelength fluctuation quantity on the basis of the wavelength control information feedbacked through the transmission line 90 of the optical transmission system 150.

Thus, the optical transmission system 150 is made up of one transmitter 10 having a different center wavelength, a dispersion compensating device 1 having a dispersion characteristic appearing repeatedly with respect to a wavelength in a predetermined wavelength band, and a wavelength control unit 33 for controlling the center emission wavelength of the one transmitter 10 on the basis of the transmission performance information measured on the reception side such as the receiver 20. In other words, the optical transmission system 150 comprises the dispersion compensating device 1 having a wavelength-dependency dispersion characteristic and made to compensate for the dispersion of a transmitted light, and the wavelength-variable transmitter 10 made to transmit light in which the center emission wavelength is shifted by a wavelength fluctuation quantity relative to the dispersion characteristic of the dispersion compensating device 1.

The above description is summarized as follows. That is, this dispersion compensating method is for use in the optical transmission system 150 including the transmitting-side optical transmission unit (transmitter 10) and the receiving-side optical transmission unit (receiver 20).

The receiver 20 acquires a dispersion quantity relative to a single-wavelength light outputted from the wavelength-variable transmitter 10 provided in the transmitter 10 for outputting a single-wavelength light (dispersion quantity acquiring step). The receiver 20 transmits, to the transmitter 10, wavelength control information relative to a target (desired) dispersion on the basis of the dispersion quantity acquired in the dispersion quantity acquiring step (transmission step). Moreover, the receiver 20 varies the wavelength of the transmitter 10 on the basis of the wavelength control information transmitted in the transmission step (fluctuation step).

In addition, in the aforesaid transmission step, the receiver 20 can be made to transmit, to the transmitter 10, the wavelength control information including one of or both the dispersion quantity information and the transmission performance information so that the wavelength control unit 33 acquires the wavelength control information corresponding to the target dispersion quantity. This enables the adjustment to the optimum residual dispersion value as the system.

In this case, as the methods for the target dispersion quantity, for example, there are a method of employing a dispersion quantity in each channel at the system design, a method of employing a dispersion quantity in each channel determined on the basis of a system design parameter (for example, transmission distance, loss or the like), and a method of determining a target dispersion quantity in one channel and calculating a target dispersion quantity on the basis of a dispersion slope with respect to other channels.

(C) Description of Second Embodiment of the Present Invention

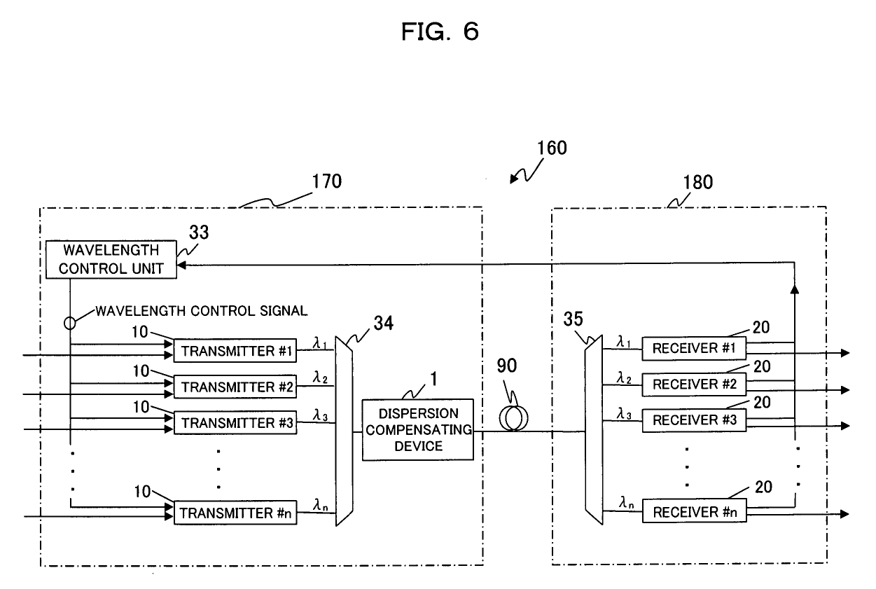

FIG. 6 is an illustration of an example of a configuration of a WDM transmission system according to a second embodiment of the present invention. In FIG. 6, a WDM transmission system 160 is made up of a transmission terminal node 170, a transmission line 90 and a reception terminal node 180. The transmission terminal node 170 is composed of n wavelength-variable transmitters 10 (#1 to #n) for transmitting single-wavelength lights corresponding to wavelengths λ₁ to λₙ, respectively, a multiplexer 34, a wavelength control unit 33, and a dispersion compensating device 1 having a wavelength-dependency dispersion characteristic and made to compensate for the dispersion of a transmitted light.

The transmitters 10 (#1 to #n) are such that their wavelengths are respectively variable (tunable) about the their center emission wavelengths λ₁ to λₙ under control from the external, and are made to transmit single-wavelength light with a wavelength shifted by a wavelength fluctuation quantity relative to the dispersion characteristic of the dispersion compensating device 1 and, for example, includes a tunable laser diode as a light-emitting element. Moreover, each wavelength corresponds to each wavelength prescribed in, for example, the ITU grid.

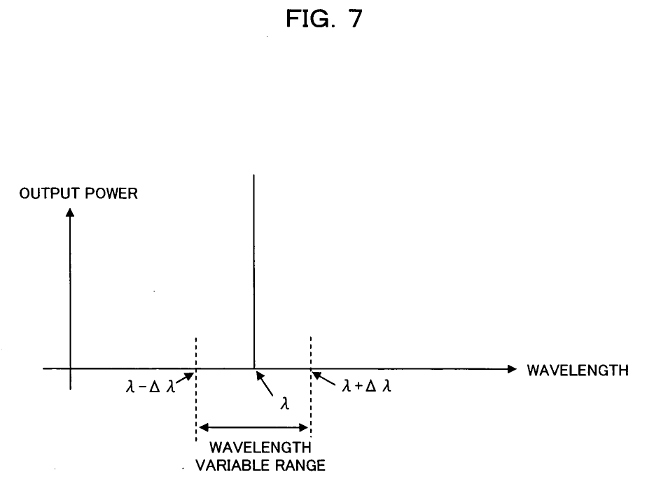

FIG. 7 is an illustration of one example of an oscillation characteristic of a tunable laser diode. The tunable laser diode has a wavelength-variable range of oscillation wavelength shown in FIG. 7, and its center emission wavelength is adjustable in a range of ±Δλ with respect to the wavelength λ by, for example, temperature control.

The wavelength control unit 33 (FIG. 6) is made to control the center emission wavelength of each corresponding transmitter 10 (#1 to #n) on the basis of one of or both the actual dispersion quantity information acquired in each receiver 20 (#1 to #n) of the reception terminal node 180 and the transmission performance information such as BER or error correction frequency.

Moreover, the multiplexer 34 multiplexes signal lights with wavelengths from the n transmitters 10 for producing a WDM light and is not always required to have the dispersion characteristic indicated by C12 in FIG. 1, but a common optical characteristic is acceptable.

Still moreover, the dispersion compensating device 1 (FIG. 6) has the dispersion characteristic indicated by C12 in FIG. 1 and is made to compensate for the dispersion of a transmitted light, with it being located on the output side of the multiplexer 34. Yet moreover, each transmitter 10 of the transmitting-side transmission terminal node 170 is made to output a single-wavelength light with a wavelength obtained by shifting a wavelength of a single-wavelength light by a quantity corresponding to a predetermined wavelength on the basis of the dispersion characteristic of the dispersion compensating device 1. The WDM transmission system 160 shown in FIG. 6 varies the center emission wavelength of each transmitting-side channel, thus realizing a function similar to the variable dispersion compensation function of the optical transmission system 150 shown in FIG. 5.

This dispersion compensating device 1 has a characteristic that its dispersion quantity varies largely around the center emission wavelength (λ₁, λ₂, . . . , λₙ) of each of single-wavelength lights constituting the WDM light, and is realized through the use of, for example, an etalon filter. In the etalon filter having the characteristic shown in FIG. 2, its dispersion characteristic has a periodicity, and the etalon filter is suitable for use in this embodiment, i.e., the WDM transmission system 160.

In this connection, the location of the dispersion compensating device 1 is not limited to the transmission terminal node 170 but it can also be located in the reception terminal node 180, both the transmission terminal 170 and reception terminal node 180, or in a repeater (see FIG. 14, mentioned later) provided in the transmission line 90 as needed, which can provide similar effects.

Therefore, the transmission terminal node (optical transmission apparatus) 170 is made up of n transmitters 10 (#1 to #n) whose center emission wavelengths are different from each other, a dispersion compensating device 1 having a dispersion characteristic appearing repeatedly with respect to a wavelength in a predetermined wavelength band, and a wavelength control unit 33 for controlling the center emission wavelengths of one or n transmitters 10 (#1 to #n) on the basis of the transmission performance information measured in, for example, the reception side such as the reception terminal node 180.

Moreover, the reception terminal node 180 is composed of n receivers 20 (#1 to #n) respectively corresponding to wavelengths λ₁ to λₙ, and a demultiplexer 35. the demultiplexer 35 is for demultiplexing the transmitted WDM light into signal lights with wavelengths. It is not always required to have the dispersion characteristic indicated by C12 in FIG. 1, and a common optical characteristic is acceptable.

Thus, this dispersion compensating method is for use in the WDM transmission system (optical transmission system) 160 equipped with two or more optical transmission apparatus including the transmitting-side optical transmission apparatus (transmission terminal node 170) and the receiving-side optical transmission apparatus (reception terminal node 180).

First of all, the reception terminal node 180 acquires a dispersion quantity of each of the wavelength-variable transmitters 10 provided in the transmission terminal node 170 for outputting a single-wavelength light (dispersion quantity acquiring step).

Following this, the reception terminal node 180 transmits, to the transmission terminal node 170, wavelength control information corresponding to a target dispersion quantity on the basis of the dispersion quantity acquired in the dispersion quantity acquiring step (transmission step).

Subsequently, the transmission terminal node 170 fluctuates the wavelength of the transmitter 10 on the basis of the wavelength control information transmitted in the transmission step (fluctuation step).

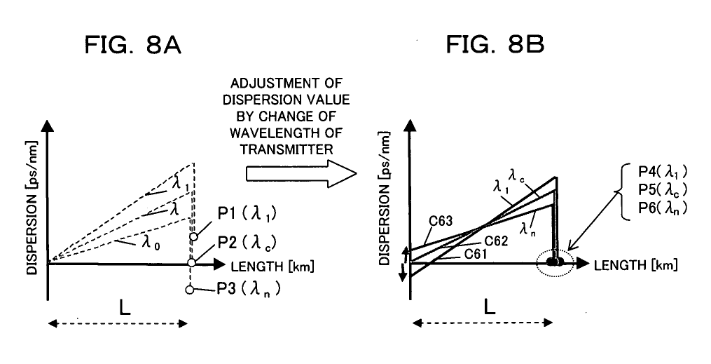

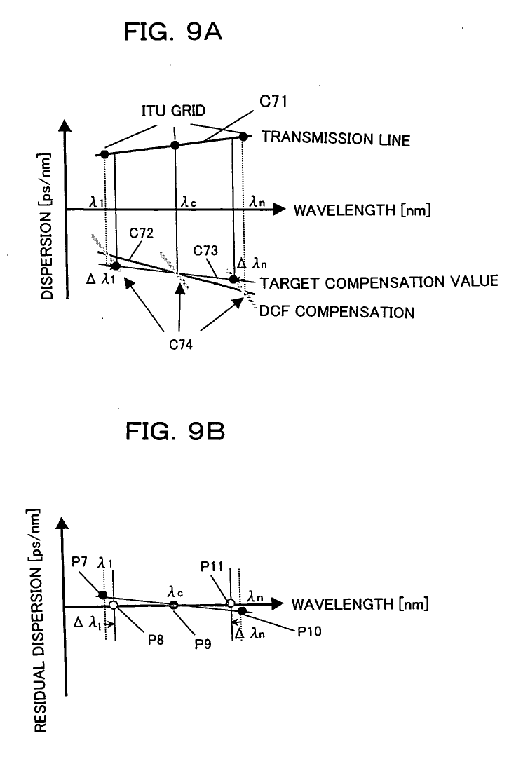

Furthermore, referring to FIGS. 8A and 8B, a description will be given hereinbelow of a dispersion map representative of a fluctuation of a dispersion quantity with respect to a transmission distance, and referring to FIGS. 9A and 9B, a detailed description will be given hereinbelow of a dispersion compensation quantity in the case of the employment of a common dispersion compensator and of a dispersion compensation quantity in the case of the employment of the dispersion compensating device 1.

FIGS. 8A and 8B are illustrations for explaining the effects in the case of the application of the present invention to a WDM transmission system according to a dispersion map indicative of a dispersion quantity with respect to a transmission distance, and FIGS. 9A and 9B are illustrations for explaining the effects in the case of the application of the present invention to a WDM transmission system according to a dispersion quantity with respect to a wavelength.

FIG. 8A is an illustration of one example of a common dispersion map, and shows a case in which, in the WDM transmission system 160 shown in FIG. 6, a DCF is provided on the reception side to carry out the dispersion compensation and the wavelength of a single-wavelength light to be outputted from each transmitter 10 is set at the center wavelength (for example, λ₁, λ_{c}, λₙ thereof according to the ITU grid).

The dispersion quantity of a signal light with the wavelength λ₁ constituting the WDM light increases with an increase in the transmission distance, and it is compensated for through the use of a dispersion compensator such as a DCF provided on the reception side so as to reach a dispersion quantity (residual dispersion quantity) indicated by a point P1. As well as the dispersion quantity relative to the wavelength λ₁, the dispersion quantities of the signal light with the wavelength λ_{c}, λₙ are also compensated for by a dispersion compensator such as a DCF to become the residual dispersion quantities indicated by the points P2 and P3, respectively.

With respect to the wavelengths λ₁, λ_{c} and λₙ, the residual dispersion quantities (indicated by white circles) at the points P1 to P3 are different from each other. This is because, even if a DCF having an inverse dispersion slope characteristic is used for the purpose of, for example, offsetting a dispersion slope of a transmission line, difficulty is experienced in completely offsetting the dispersion slopes in all the channels (the respective wavelengths constituting WDM).

For this reason, for example, even if a DCF is selected to provide the optimum residual dispersion quantity (point P2) with respect to the wavelength λ_{c}, there is a possibility that the dispersion compensation quantity runs short with respect to the wavelength λ₁ (point P1) while the dispersion compensation quantity goes to excess with respect to the wavelength λₙ (point P3).

FIG. 8B is an illustration of one example of a dispersion map according to the first embodiment of the present invention. With respect to the light with the wavelength λ₁ for which the dispersion compensation quantity comes short as mentioned with reference to FIG. 8A, the system shifts the center wavelength λ₁ of the transmitter 10 (which will hereinafter be referred to as a transmitter 10#1, and the other transmitters 10 will also referred to in like manner) corresponding to the wavelength λ₁ by Δλ₁ toward a longer-wavelength side so that it becomes wavelength (λ₁+Δλ₁). At this time, for example, in a case in which the dispersion compensating device 1 is on the transmission side, as indicated by C61 in FIG. 8B, a negative dispersion occurs due to the dispersion compensating device 1 at a transmission end, i.e., at a transmission distance of 0 km, and the dispersion quantity after the transmission is adjusted to P4 indicative of the optimum value.

Likewise, with respect to the center wavelength λₙ of the transmitter 10#n corresponding to the wavelength λₙ, the system shifts it by Δλₙ toward a shorter-wavelength side so that it becomes wavelength (λₙ−Δλₙ). At this time, in a case in which the dispersion compensating device is on the transmission side, as indicated by C63 in FIG. 8B, a positive dispersion occurs due to the dispersion compensating device at a transmission end, i.e., at a transmission distance of 0 km, and the dispersion quantity after the transmission is adjusted to P6 indicative of the optimum value.

Accordingly, the transmitter 10 outputs a single-wavelength light having a wavelength obtained by shifting the shortest wavelength to a long-wavelength side in the WDM light transmission band, and transmits a single-wavelength light having a wavelength obtained by shifting the longest wavelength to a short-wavelength side in the WDM light transmission band.

That is, the optimum dispersion compensation can be made with respect to each wavelength by varying the center wavelength of light to be transmitted from each transmitter 10 as needed.

FIG. 9A shows this state seen from a different perspective.

FIG. 9A shows, with respect to each wavelength for a WDM transmission system, a transmission line dispersion quantity C71, a dispersion compensation quantity (DCF compensation quantity) C72 due to a common dispersion compensator such as a DCF, a target dispersion compensation quantity C73, and a dispersion compensation quantity C74 due to the dispersion compensating device 1.

Paying notice to the wavelength λ₁, the absolute value of the DCF compensation quantity runs short with respect to the absolute of the transmission line dispersion quantity C71. In this case, when the center wavelength of the transmitter 10 is set at λ₁+Δλ₁, the absolute value of the dispersion quantity increases, which enabling the adjustment to the absolute value of the transmission line dispersion quantity C71 for the optimum dispersion compensation quantity.

Moreover, paying notice to the wavelength λₙ, the absolute value of the DCF compensation quantity goes to excess with respect to the absolute of the transmission line dispersion quantity C71. In this case, when the center wavelength of the transmitter 10 is set at λₙ−Δλₙ, the absolute value of the dispersion quantity decreases, which also enabling the adjustment to the absolute value of the transmission line dispersion quantity C71 for the optimum dispersion compensation quantity.

Therefore, the transmitter 10 of the transmission terminal node 200 outputs a single-wavelength light having a wavelength obtained by shifting the shortest wavelength to the long-wavelength side in the WDM light transmission band and outputs a single-wavelength-light having a wavelength obtained by shifting the longest wavelength to the short-wavelength side in the WDM light transmission band.

When this adjustment is implemented with respect to each wavelength constituting the WDM light, it is possible to realize a WDM transmission system having the optimum dispersion compensation quantity for all the channels.

When the transmission side wavelength is changed on the basis of the transmission line information detected on the reception side in this way, the dispersion value of the dispersion compensating device 1 varies to enable the appropriate dispersion compensation.

FIG. 9B shows a residual dispersion with respect to each wavelength constituting the WDM light in FIG. 9A.

With respect to the wavelength λ₁, the residual dispersion value is larger than, for example, 0 ps/nm forming the optimum value (point P7). In this case, when the center wavelength of the transmitter 10 is set at λ₁+Δλ₁, the dispersion compensation quantity decreases (the negative absolute value increases), thus adjusting the residual dispersion value to the optimum value (point P8). That is, the residual dispersion value is adjustable from the point P7 to the point P8 in FIG. 9B.

Likewise, with respect to the wavelength λₙ, the residual dispersion value is smaller than, for example, 0 ps/nm forming the optimum value (point P10). In this case, when the center wavelength of the transmitter 10 is set at λₙ−Δλₙ, the dispersion compensation quantity increases (the negative absolute value decreases), thus adjusting the residual dispersion value to the optimum value (point P11). That is, the residual dispersion value is shiftable from the point P10 to the point P11 in FIG. 9B.

As described above, according to this dispersion compensating method, the residual dispersions of all the channels can be set the optimum values by fine-adjusting the center emission wavelength of each channel constituting the WDM light.

(D) Description of Third Embodiment of the Present Invention

Although, in the second embodiment shown in FIG. 6, the dispersion compensating device 1 having the dispersion characteristic indicated by C12 in FIG. 1 is independently provided at the latter stage of the multiplexer 34 as described above, the above-mentioned respective functions are also realizable through the use of even a multiplexer or demultiplexer having the dispersion characteristic indicated by C12 therein.

Moreover, the above-mentioned respective functions are also realizable if a dispersion characteristic forming a combination of dispersion characteristics of a multiplexer and a demultiplexer becomes the dispersion characteristic indicated by C12 in FIG. 1.

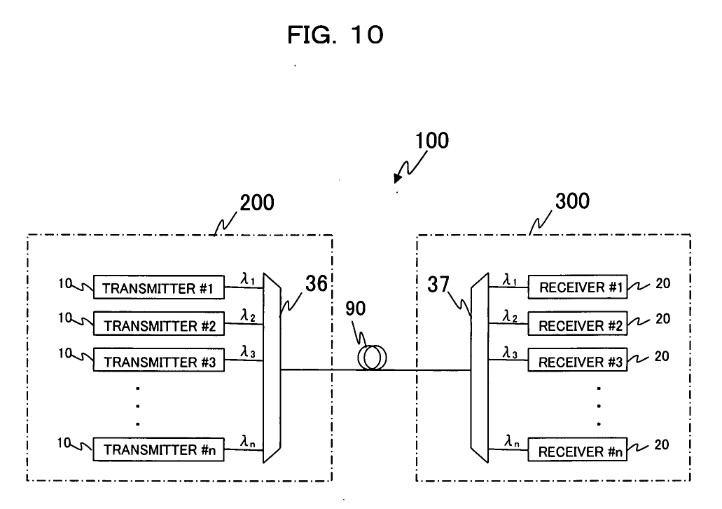

FIG. 10 is an illustration of an example of a configuration of a WDM transmission system 100 according to a third embodiment of the present invention. The WDM transmission system 100 is made up of a transmission terminal node 200, a reception terminal node 300 and a transmission line 90.

The transmission terminal node 200 is composed of transmitters 10 (#1 to #n) having center emission wavelengths of λ₁ to λₙ, respectively, and made wavelength-variable in a center emission wavelength band and a multiplexer 36 for transmitting a WDM light, obtained by multiplexing lights with these wavelengths, to the transmission line 90.

The reception terminal node 300 is composed of a demultiplexer 37 for demultiplexing the WDM light from the transmission line 90 into lights with wavelengths and receivers 20 (#1 to #n) corresponding to the demultiplexed wavelengths λ₁ to λₙ, respectively.

In this embodiment, the multiplexer 36 has the dispersion characteristic indicated by C12 in FIG. 1, while the demultiplexer 37 is a common device which does not have such a characteristic.

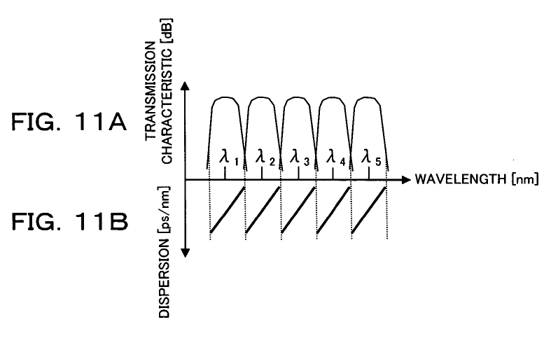

FIG. 11A is an illustration of one example of a transmission characteristic of the multiplexer 36.

In FIG. 11A, the transmission characteristic curve indicates a transmission characteristic with respect to each of the single-wavelength lights λ₁ to λₙ, and the maximum transmission quantity develops at the center wavelength of each of the single-wavelength lights λ₁ to λₙ. In addition, this transmission characteristic curve has a periodicity, where the portions other than the band around the wavelengths λ₁ to λₙ constituting the WDM light are cut.

Furthermore, FIG. 11B is an illustration of one example of a dispersion characteristic of the multiplexer 36. The dispersion characteristic curve shown in FIG. 11B is such that the dispersion quantity increases with an increase of the wavelength λ in the transmission band corresponding to each of the channels constituting the WDM light while the dispersion quantity decreases with a decrease of the wavelength λ.

Incidentally, it is also acceptable that a dispersion characteristic forming a combination of the dispersion characteristics of the multiplexer 36 and the demultiplexer 37 becomes the dispersion characteristic shown in FIG. 11B. That is, it is also appropriate that the dispersion compensation characteristic of a dispersion compensator to which the present invention is applied is realized by adding the dispersion characteristic of the multiplexer 36 and the dispersion characteristic of the demultiplexer 37.

With this arrangement, the multiplexer 36 (the demultiplexer 37, or both the multiplexer 36 and demultiplexer 37) additionally has the characteristic of the dispersion compensating device 1 needed in the second embodiment, which eliminates the need for developing the dispersion compensating device 1 as a separate device and the need for considering the insertion loss thereof, thus realizing an optical transmission system easy in system design at a lower cost.

In FIG. 10, the same reference numerals as those used in the above description designate the same parts.

Moreover, it is also possible that, without the employment of the dispersion compensating device 1, a multiplexer having a common characteristic is provided on the transmission side while a demultiplexer having a characteristic of the dispersion compensating device 1 using an etalon type interleaver is provided on the reception side. Alternatively, it is also possible that, without the employment of the dispersion compensating device 1, a multiplexer having a characteristic of the dispersion compensating device is located on the transmission side and a demultiplexer having a common characteristic is employed. That is, only one of the multiplexer and the demultiplexer can possess the total dispersion characteristic. A more detailed description will be given hereinbelow of a case in which an interleaver having a dispersion characteristic similar to that of the dispersion compensating device 1 is employed as a demultiplexer.

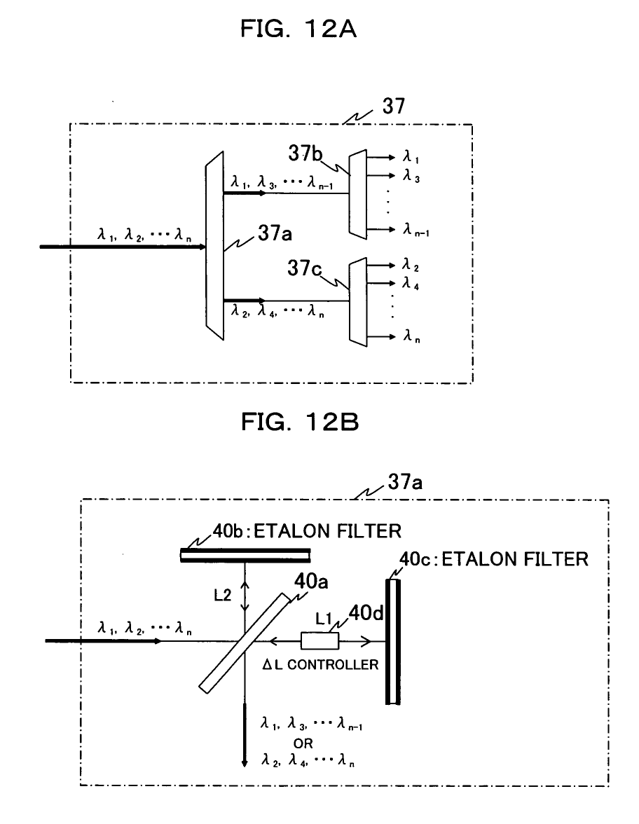

FIG. 12A is an illustration of a configuration of a demultiplexer using an etalon type interleaver according to the third embodiment of the present invention. In FIG. 12A, a demultiplexer 37 is composed of an interleaver (optical splitter) 37a and latter-stage demultiplexers 37b and 37c.

The interleaver 37a is for demultiplexing the channels λ₁, λ₂, . . . , λₙ of the inputted WDM light into odd channels λ₁, λ₃, . . . ,λₙ₋₁ and even channels λ₂, λ₄, . . . , λₙ and for setting the transmission wavelength spacing at twice the original wavelength (λ₁, λ₂, λ₃, λ₄, . . . , λₙ) spacing, which can relax the demultiplexing characteristic conditions of the latter-stage demultiplexers 37b and 37c.

In addition, the latter-stage demultiplexers 37b and 37c are for demultiplexing the odd channels and the even channels, respectively.

FIG. 12B is an illustration useful for explaining the interleaver 37a according to the third embodiment of the present invention. In FIG. 12B, the interleaver 37a includes a beam splitter (BS) 40a, etalon filters 40b, 40c, and a controller 40d. The beam splitter 40a is for making the reflection and transmission on an incident light at a predetermined ratio (for example, 50% for each), and each of the etalon filters 40b and 40c is for making the reflection on the incident light, and the controller 40d is for adjusting the distance between the beam splitter 40a and the etalon filter 40c.

Thus, the WDM light containing the wavelengths λ₁, λ₂, λ₃, λ₄, . . . , λₙ₋₁, λₙ is transmitted and reflected by the beam splitter 40a. At this time, the light passing through the beam splitter 40a and reflected by the etalon filter 40c and the light reflected by the beam splitter 40a and reflected by the etalon filter 40b are different in phase condition from each other, thereby outputting only wavelengths whose phase conditions match with each other to interact in an increasing direction. Moreover, when the controller 40d adjusts the distance between the beam splitter 40a and the etalon filter 40c, a change of the phase condition takes place, thereby outputting a light having a desired wavelength.

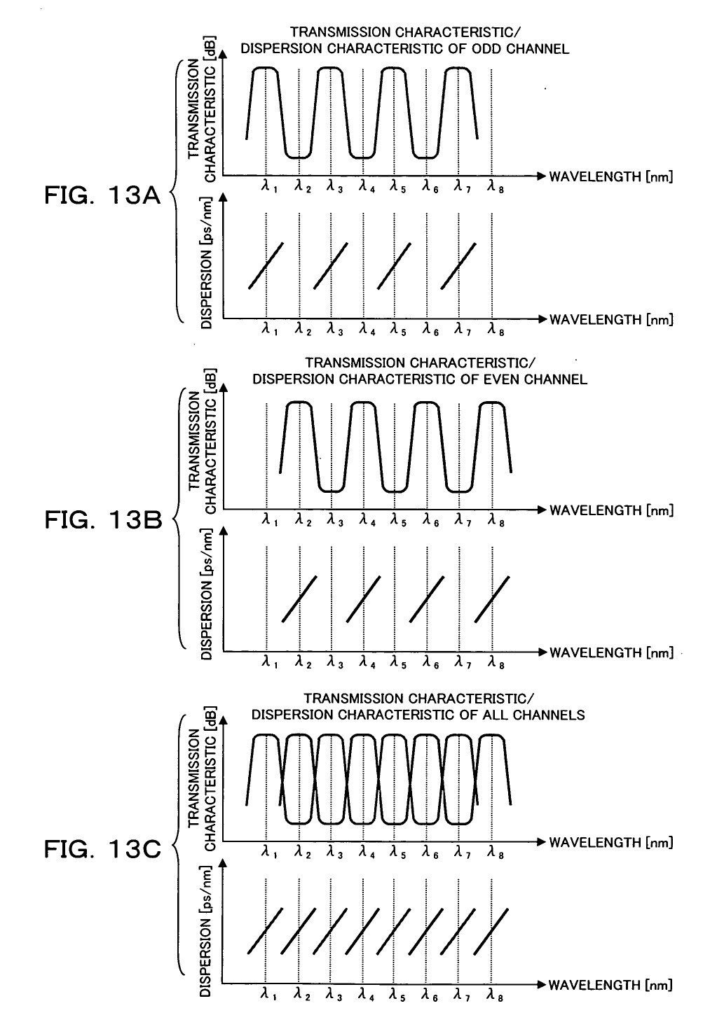

Referring to FIGS. 13A to 13C, a description will be given hereinbelow of examples of a transmission characteristic and dispersion characteristic of the demultiplexer 37 using an etalon type inteleaver.

FIG. 13A is an illustration of a transmission characteristic and a dispersion characteristic for odd channels according to the third embodiment of the present invention. The transmission characteristic shown in FIG. 13A makes the transmission of the odd channels λ₁, λ₃, . . . , λₙ₋₁.

FIG. 13B is an illustration of a transmission characteristic and a dispersion characteristic for the even channels according to the third embodiment of the present invention. The transmission characteristic shown in FIG. 13B makes the transmission of the even channels λ₂, λ₄, . . . , λₙ.

FIG. 13C is an illustration of a transmission characteristic and a dispersion characteristic for all the channels according to the third embodiment of the present invention. The transmission characteristic shown in FIG. 13C is obtained by the adding processing on the transmission characteristics and the dispersion characteristics shown in FIGS. 13A and 13B. With respect to all the channels, it makes the transmission of each of λ₁, λ₂, . . . , λₙ and, in each of the wavelength bands, a sharp dispersion characteristic develops with respect to a wavelength and is equivalent to that of the above-mentioned dispersion compensating device 1.

Furthermore, the employment of the demultiplexer 37 realizes a transmission characteristic which can sufficiently suppress components of adjacent channels of single-wavelength light as shown in FIGS. 12A and 12B. In this respect, in light of the WDM transmission, the transmission characteristic of the demultiplexer 37 made using a common reflection filter is more advantageous than the characteristic expressed by a sin (sine) function.

Incidentally, a multiplexer (not shown), which uses the etalon filters 40b and 40c, can also sufficiently suppress the adjacent channel components of single-wavelength light.

Thus, the dispersion compensating device 1 (FIG. 6) is realizable as (i) a demultiplexer made to demultiplex a WDM light, (ii) a multiplexer made to multiplex single-wavelength lights, or (iii) a combination of one or a plurality of demultiplexing units for a WDM light and one or a plurality of multiplexers for multiplexing single-wavelength lights corresponding in number to the wavelength channels.

In other words, when the dispersion characteristic of the dispersion compensating device 1 in the second embodiment involves the total dispersion characteristic based on the respective dispersion characteristics of one or plurality of multiplexers or demultiplexers, the present invention is realizable.

A detailed description will be given hereinbelow of a case of dispersion compensation in a mode including a combination of the multiplexer 36 and the demultiplexer 37.

(D1) Description of First Modification of Third Embodiment of the Present Invention

A description will be given hereinbelow of a method in which the reception side measures a dispersion quantity so that the measured dispersion quantity is feedbacked to the transmission side to control each wavelength.

FIG. 14 is an illustration of an example of a configuration of an optical transmission system according to a first modification of the third embodiment of the present invention. In FIG. 14, a WDM transmission system (optical transmission system) 100a is made up of a transmission/reception terminal node 200a having a WDM light transmission/reception function, a transmission/reception terminal node 300a and an inline amplifier 50.

In this configuration, the transmission/reception terminal node 200a is composed of n transmitters 10, a multiplexer 36, a wavelength control unit 33, a dispersion measuring device (dispersion measuring unit) 44a, a coupler 43, an amplifier 49, a DCF 35 and an OSC light transmitter 46a.

The amplifier 49 of the transmission/reception terminal node 200a is for collectively amplifying a WDM light from the multiplexer 36. Moreover, the DCF 35 of the transmission/reception terminal node 200a is for collectively compensating for the dispersion of the WDM light, and functions as a dispersion compensator (DCT: Dispersion Compensator for Transmitting)on the transmission side. For example, this DCF 35 is of a negative type having negative wavelength dispersion and is selected to realize a compensation quantity determined at design in advance. Incidentally, as this DCF 35, as needed, there is sometimes employed a device having positive wavelength dispersion.

Moreover, the OSC light transmitter 46a is for transmitting an OSC light to the transmission line 90, and it is made to monitor control information to the inline amplifier 50 and the transmission/reception terminal node 300a which will be mentioned later.

Still moreover, the dispersion measuring device 44a is for producing a dispersion measurement signal, with the information (dispersion measurement control signal) on the start or stop of the dispersion measurement (dispersion measurement processing ON or OFF) being inputted thereto from the wavelength control unit 33.

The coupler 43 is for coupling the dispersion measurement signal produced in the dispersion measuring device 44a with the WDM light outputted from the multiplexer 36. It is preferable that this dispersion measurement signal has the same wavelength as that of the WDM light. This is for reproducing the environmental and physical conditions such as the dispersion, dispersion slope and non-linear optical effect in the same channel, which occur when various types of signal lights are transmitted, thereby making high-accuracy measurement. Therefore, separately from the activation or stop of the transmission/reception terminal node 200a, the system has a function to set the ON/OFF of the dispersion measurement signal to be produced by the dispersion measuring device 44a. The measurement of the dispersion quantity, using the dispersion measuring device 44a and the reception side dispersion measuring device 44b, can also be made for each part, such as an optical fiber or the DCF 35.

In this connection, without the coupler 43, it is also possible to measure the dispersion quantity through the use of the reception side dispersion measuring device 44b in a state where the dispersion measuring device 44a is connected to the amplifier 49.

Moreover, both the DCF 35 and the amplifier 49 provided in the transmission/reception terminal node 200a can also be located in the exterior of the apparatus (body of equipment) of the transmission/reception terminal node 200a. The transmitters 10, the multiplexer 36 and the wavelength control unit 33 are the same as those mentioned above.

The inline amplifier 50 is for carrying out the amplification and dispersion compensation on the WDM light, and it is composed of an OSC light transmitter/receiver 46 having both transmission and reception functions to transmit and receive an OSC light, an amplifier 49 and a DCF 35. Thus, the received WDM light is amplified in the inline amplifier 50 and the amplified WDM light is led to the DCF 35 so that the dispersion compensation on all the wavelength bands is collectively made therein.

The transmission/reception terminal node 300a is equipped with an OSC light receiver 46b. This OSC light receiver 46b is made to receive monitor control information. The description on the above-mentioned amplifier 49, DCF 35, demultiplexer 37 and n receivers (second receivers) 20 will be omitted for avoiding the repetition. In the following description, the respective receivers 20 will be expressed as receivers #1 to #n relative to the demultiplexed wavelengths λ₁ to λₙ. Incidentally, both the DCF 35 and the amplifier 49 in the transmission/reception terminal node 300a can also be located in the exterior of the apparatus of the transmission/reception terminal node 300a.

In the above-described configuration, the transmission/reception terminal node 300a measures a dispersion quantity in the system through the use of the dispersion measuring device 44b, which receives a dispersion measurement signal produced by the dispersion measuring device 44a, with wavelength control information corresponding to a desired dispersion quantity being feedbacked to the transmission/reception terminal node 200a on the basis of the measured dispersion quantity.

In addition, the wavelength control unit 33 controls the center emission wavelength of each of the transmitters #1 to #n on the basis of the transferred wavelength control information. The dispersion quantity relative to each wavelength varies in accordance with a wavelength controlled variable for each wavelength so that the optimum residual dispersion quantity is obtainable.

Still additionally, as described above, as the method of feedbacking the actual dispersion quantity information, the transmission performance information and others from the reception side to the transmission side, there are employable a method of transferring them in a state included in the up-direction OSC light, a method of transferring them through a monitor control apparatus (not shown) made to carry out the monitor control on the entire system, a method of transferring them in a state included in the up-direction main signal.

Incidentally, although in FIG. 14 and the portion of the specification corresponding thereto the OSC light transmitter 46a, the OSC optical transmitter/receiver 46 and the OSC light receiver 46b have been illustrated and described, as obvious from the operation of the present invention, these components are not always necessary.

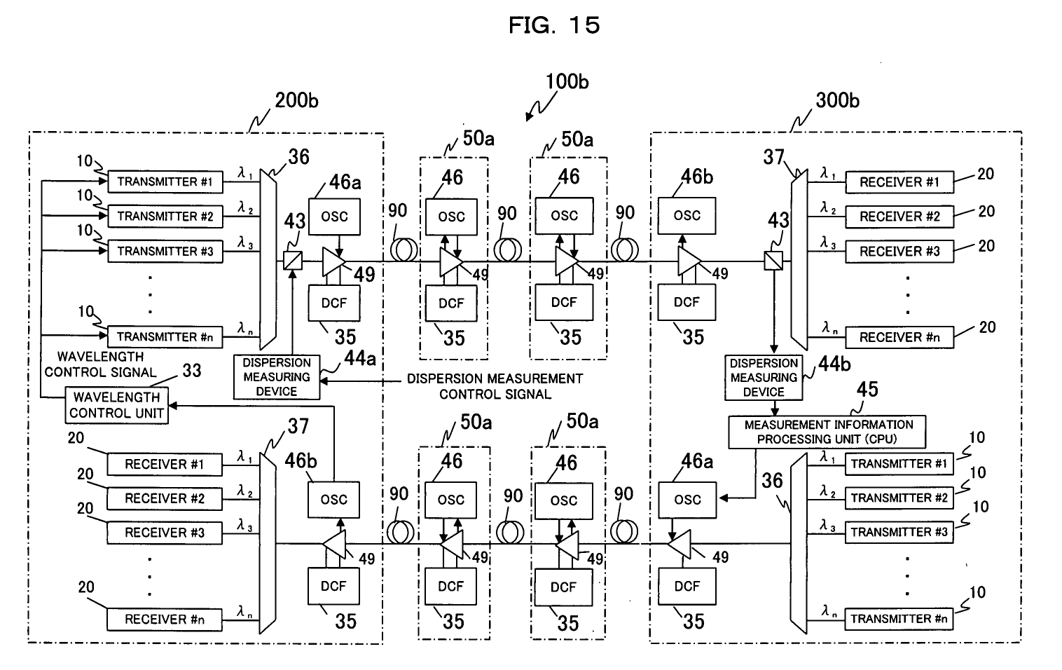

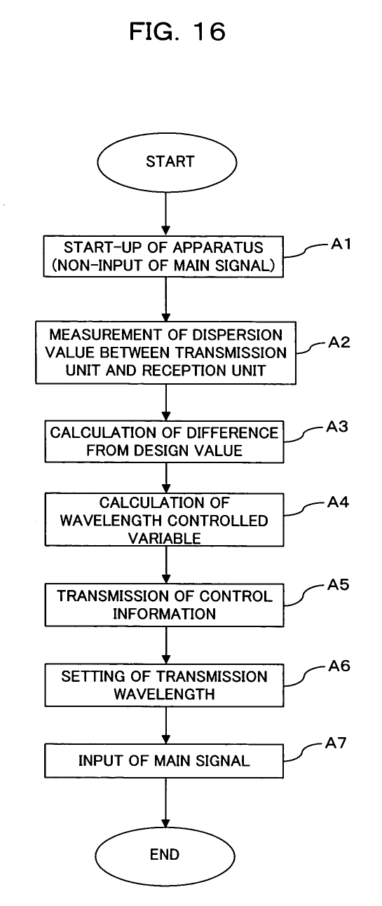

Furthermore, referring to FIGS. 15 and 16, a description will be given hereinbelow of a dispersion quantity measuring method and a transmission wavelength control method according to the first modification of the third embodiment of the present invention.

In this example, the information to be feedbacked is transferred in a state included in the up-direction OSC light.

FIG. 15 is an illustration of a configuration of a WDM transmission system 100b according to the first modification of the third embodiment of the present invention. In this example, a transmission/reception terminal node 300b measures the dispersion in the down-direction from a transmission/reception terminal node 200b to the transmission/reception terminal node 300b, and transmits the measured dispersion quantity data to the transmission/reception terminal node 200b through the use of the up-direction OSC light in a transmission line 90.

In this case, the transmission/reception terminal node 200b is made up of a transmission function unit (n transmitters 10, a multiplexer 36, an amplifier 49, a DCF 35) having a WDM light transmission function, an OSC light transmitter 46a for transmitting monitor control information, a measurement function unit (dispersion measuring device 44a) for measuring a dispersion quantity in a down-direction transmission line from the transmission/reception terminal node 200b to the transmission/reception terminal node 300b, a reception function unit (n receivers 20, a demultiplexer 37, an amplifier 49, a DCF 35) for receiving a WDM light in the up-direction from the transmission/reception terminal node 300b, an OSC light receiver 46b for receiving monitor control information, and a wavelength control unit 33.

The transmission/reception terminal node 300b is made up of a reception function unit (n receivers 20, a demultiplexer 37, an amplifier 49, a DCF 35) having a WDM light reception function, an OSC light receiver 46b for receiving a monitor control signal, a measurement function unit (a coupler 43, a dispersion measuring device 44b, a measurement information processing unit 45) for measuring a dispersion quantity of the received dispersion measurement signal, a transmission function unit (n transmitters 10, a multiplexer 36, an amplifier 49, a DCF 35) for transmitting a WDM light to the transmission/reception terminal node 200b, and an OSC light transmitter 46a.

In this case, one of the multiplexer 36 and the demultiplexer 37, or a combination of the multiplexer 36 and the demultiplexer 37, realizes the dispersion characteristic indicated by C12 in FIG. 1 with respect to the respective wavelengths λ₁ to λₙ.

The same reference numerals as those used above designate the same parts.

The measurement information processing unit 45 makes a comparison between a desired reference dispersion quantity (which will hereinafter be referred to as a reference dispersion quantity) previously set, for example, at the system design and an actual dispersion quantity relative to each wavelength measured by the dispersion measuring device 44b to produce wavelength control information for each wavelength on the basis of the magnitude of difference from the desired dispersion quantity.

This wavelength control information is transferred as a portion of the up-direction OSC light monitor control information to the transmission/reception terminal node 200b.

As the wavelength control information, for example, there is used “shifting by 0.1 nm to the long-wavelength side”, “shifting by 0.05 nm to the short-wavelength side”, or the like with respect to each wavelength. This data is only one example and it can be processed in a state diversely changed. Moreover, the function of the measurement information processing unit 45 is realizable by, for example, the cooperative operations of a CPU (Central Processing Unit), a ROM (Read Only Memory) and a RAM (Random Access memory) and others.

The wavelength control unit 33 of the transmission/reception terminal node 200b is almost the same as that shown in FIG. 5 and controls the wavelengths of one or more transmitters 10 (#k) of the n transmitters 10 (#1 to #n) on the basis of the wavelength control information received from the transmission/reception terminal node 300b through the OSC.

As the method of notifying information in a case in which each transmitter 10 is controlled from the wavelength control unit 33, for example, there are the following methods. As a first method, there is a method in which the wavelength control unit 33 individually notifies the wavelength control information to the transmitter 10 #k (for example, the transmitter 10 #1), and as a second method, there is a method in which the wavelength control unit 33 performs the notification through the use of an enable signal for designating the transmitter 10 and the actual wavelength control information. In the second method, as one example of the logic on the enable signal, ON “1” is set with respect to the transmitter 10 which is an object of wavelength control, while OFF “0” is set with respect to the transmitter 10 which is not an object of control. That is, when carrying out the wavelength control on the transmitter 10 #1, the wavelength control unit 33 outputs the enable signal set to ON “1”, and the wavelength control information to the transmitter 10 #1, and sets the enable signal at OFF “0” with respect to the other transmitters 10 (#2 to #n).

In addition, the wavelength control unit 33 is made to control the wavelength fluctuation quantity on the basis of transmission performance information from a monitor unit which acquires information on the transmission performance of the optical transmission system 150.

Thus, in the transmission/reception terminal node 300b, a dispersion quantity is measured with respect to each wavelength and the wavelength control information for achieving a desired residual dispersion value is transmitted to the transmission/reception terminal node 200b to carry out the feedback control, thereby acquiring the optimum residual dispersion quantity with respect to each wavelength.

The concrete operation is as follows.

That is, (i) the dispersion measuring device 44a of the transmission/reception terminal node 200b transmits a dispersion measurement signal in the down-direction, and (ii) the dispersion measuring device 44b of the downstream side transmission/reception terminal node 300b measures a dispersion quantity in a range from the transmission/reception terminal node 200b to the transmission/reception terminal node 300b, and (iii) upon receipt of this, the measurement information processing unit 45 transfers the wavelength control information for achieving the optical dispersion quantity to the OSC transmitting unit 46a on the transmission/reception terminal node 300b side for transmitting it as an OSC light to the upstream side transmission/reception terminal node 200b, and (iv) when receiving the wavelength control information through the OSC receiving unit 46b, the wavelength control unit 33 outputs a control signal (wavelength fluctuation quantity control signal) indicative of a wavelength fluctuation quantity to a desired transmitter 10 #k of the transmitters 10 (#1 to #n), with (v) the center emission wavelength of each of the transmitters 10 #1 to #n being shifted by a predetermined value.

In this example, as described above, in the WDM transmission system 100b, the wavelength control information is notified to the transmission/reception terminal node 200b for controlling the center emission wavelengths of the respective transmitters 10 #1 to #n on the basis of the dispersion quantity measured in the transmission/reception terminal node 300b, and the wavelength of each of the transmitters 10 #1 to #n is controlled in the transmission/reception terminal node 200b. In this connection, in a case in which the types and lengths of the up-direction transmission lines are equal to those of the down-direction transmission lines, respectively, it is also appropriate that, instead of the above-described method, a dispersion quantity measured as feedback information from the transmission/reception terminal node 300b to the transmission/reception terminal node 200b is employed to produce predetermined wavelength control information on the transmission/reception terminal node 200b side for controlling the respective transmitters 10 #1 to #n.

FIG. 16 is a flow chart useful for explaining automatic measurement of a dispersion value and transmission wavelength control according to the first modification according to the third embodiment of the present invention.

First of all, the transmission/reception terminal node 200b is placed into activation in a state where a main signal (or WDM light) is not inputted (step A1). Subsequently, the dispersion measuring device 44a of the transmission/reception terminal node 200b outputs a dispersion measurement signal, and the dispersion measuring device 44b of the transmission/reception terminal node 300b measures a dispersion quantity between the transmission/reception terminal node 200b and the transmission/reception terminal node 300b (step A2).

The measurement information processing unit 45 calculates a difference between the measured dispersion quantity and a dispersion quantity taken at the design (step A3). Then, the measurement information processing unit 45 calculates a wavelength controlled variable (variation quantity) for adjusting the difference between the dispersion quantities (step A4).

The transmission/reception terminal node 300b transmits the wavelength controlled variable as the wavelength control information through the OSC light transmitter 46a to the transmission/reception terminal node 200b (step A5). When receiving this wavelength control information through the OSC light receiver 46b, the wavelength control unit 33 makes the setting on the basis of this information to control the wavelengths of one or more transmitters 10 #k of the transmitters 10 #1 to #n (step A6) and, in a state where the wavelengths are controlled, inputs, to the transmission line 90, the light modulated with the main signal in each of the transmitters 10 #1 to #n (step A7).

Thus, the automatic setting of the dispersion compensation quantity can be made by controlling the transmission wavelength on the basis of the measurement value of the dispersion quantity.

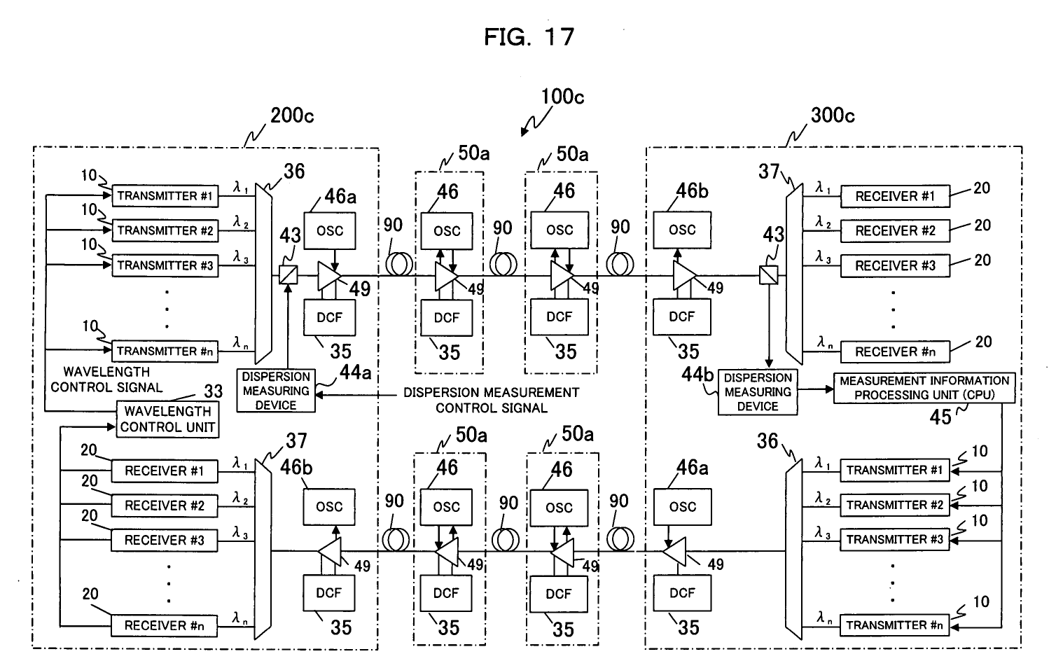

Secondly, referring to FIG. 17, a description will be given hereinbelow of a dispersion quantity measuring method and a transmission wavelength fluctuation control method in a modified configuration of the WDM transmission system 100b shown in FIG. 15.

FIG. 17 is an illustration of a configuration of another WDM transmission system according to a second modification of the third embodiment of the present invention. Although in the configuration shown in FIG. 15 the wavelength control information based on a dispersion quantity measured on the reception side (downstream side) is transferred to the transmission side (upstream side) in a state included in an OSC light, the configuration shown in FIG. 17 differs therefrom in that the wavelength control information is transferred in a state included in a main signal from the reception side to the transmission side.

A WDM transmission system 100c shown in FIG. 17 is made up of a transmission/reception terminal node 200c and a transmission/reception terminal node 300c configured as changes of the transmission/reception terminal node 200b and the transmission/reception terminal node 300b, respectively. In FIG. 17, the same reference numerals as those used above designate the same parts.

In this configuration, a wavelength control unit 33 of the transmission/reception terminal node 200c is made to receive wavelength control information from receivers 20 #1 to #n, and a measurement information processing unit 45 of the transmission/reception terminal node 300c is made to input the wavelength control information to transmitters 10 #1 to #n.

A more detailed description will be given hereinbelow of the wavelength control information input/output portions.

The measurement information processing unit 45 of the transmission/reception terminal node 300c calculates a wavelength controlled variable (quantity) on the basis of a difference the measured dispersion quantity and a dispersion quantity at the design to produce wavelength control information on the basis of this calculation result, with this wavelength control information being inputted a portion of or all of the transmitters 10 #1 to #n of the transmission/reception terminal node 300c so that the wavelength control information is inserted as the information data into a main signal light and transmitted.

The wavelength control unit 33 of the transmission/reception terminal node 200c acquires the wavelength control information from a portion of or all of the receivers 20 #1 to #n and inputs a wavelength controlled variable control signal, produced (or calculated) on the basis of the acquired wavelength control information, to the transmitters 10 #1 to #n. In other words, the wavelength control information in the WDM transmission system 100b (FIG. 15) is transmitted through the use of an OSC light, while the wavelength control information in the WDM transmission system 100c is transmitted through the use of the main signal.

Thus, in a case in which a change of a transmission route occurs due to obstacle or the like or when a portion of a transmission route comes to a stop or is switched due to the maintenance, management, test or the like of the system, without replacing the DCFs 35 provided in the transmission/reception terminal node 200c, the transmission/reception terminal node 300c and the inline amplifier 50, the compensation quantity becomes changeable by adjusting the wavelengths of the transmitters 10 #1 to #n.

Incidentally, it is also appropriate that, instead of the wavelength control information calculated on the basis of the dispersion quantity measured in the transmission/reception terminal node 300c, a dispersion quantity itself measured in the transmission/reception terminal node 300c is transmitted and required processing is conducted on the transmission/reception terminal node 200c side to produce wavelength control information.

Thus, in the WDM transmission system 100c shown in FIG. 17, the down-direction signal light wavelength is feedback-controlled through the use of the up-direction main signal light, thereby enabling the automatic setting of a compensation quantity.

(D2) Description of Second Modification of Third Embodiment of the Present invention

Secondly, a description will be given hereinbelow of a method in which the reception side measures transmission performance information (anyone of BER, Q-value and waveform, a combination thereof, or the like) and feedbacks the measured transmission performance information to the transmission side to control each wavelength.

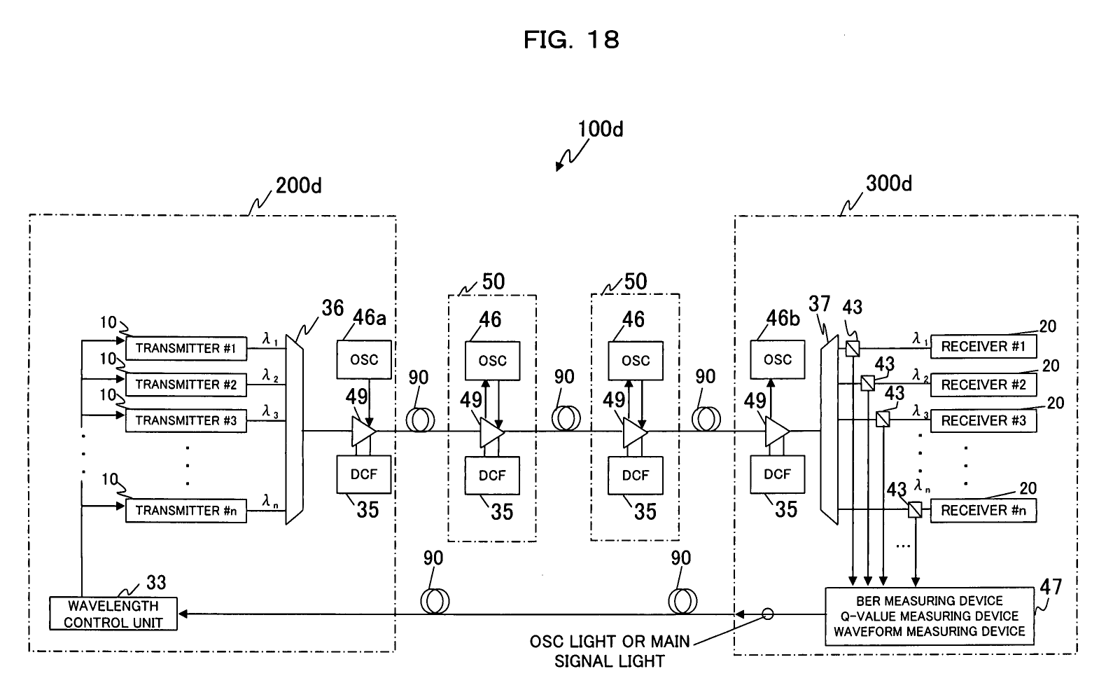

FIG. 18 is an illustration of a configuration of a WDM transmission system according to a second modification of the third embodiment of the present invention. A WDM transmission system 100d shown in FIG. 18 has a WDM light transmission function and a feedback control function on information about a transmission performance such as BER, Q-value and reception waveform. A transmission terminal node 200d has a WDM transmission function and a reception function on an OSC light or main signal light from the reception side.

A reception terminal node 300d has a reception function to receive n-waves signal lights obtained by demultiplexing a received WDM light into n-wave single-wavelength lights and a measurement function to measure, calculate or acquire transmission performance information, and n couplers 43 are provided between a demultiplexer 37 and the respective receivers 20 #1 to #n and a transmission performance information acquiring unit 47 is provided to receive the output of each of the couplers 43 for measuring, calculating and acquiring transmission performance information.

In this case, this system is made to obtain the dispersion characteristic indicated by C12 in FIG. 1 with respect to each of the wavelengths λ₁ to λₙ by means of any one of a multiplexer 36 and a demultiplexer 37 or a combination of the multiplexer 36 and the demultiplexer 37.

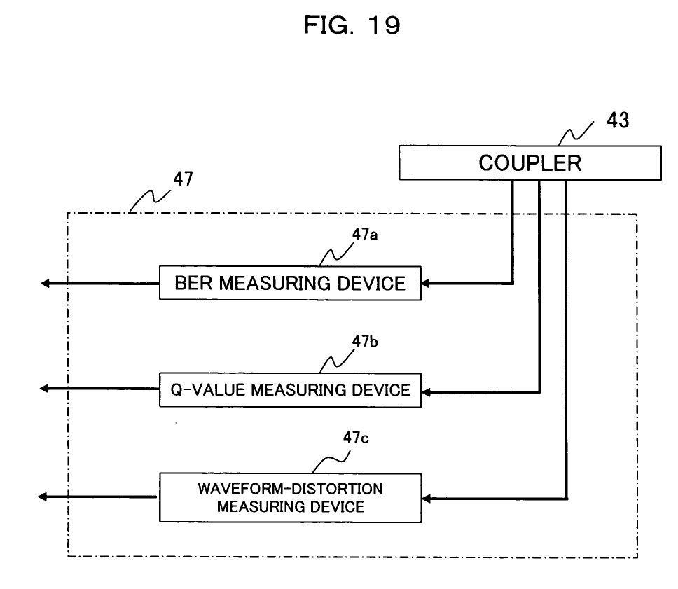

FIG. 19 is a block diagram showing the transmission performance information acquiring unit 47 according to the second modification of the third embodiment of the present invention. The transmission performance information acquiring unit 47 is composed of a BER measuring unit 47a, a Q-value measuring unit 47b and a reception waveform measuring unit (waveform-distortion measuring device) 47c.

Although in this embodiment the BER, Q-value and reception waveform are measured as the transmission performance information, it is also acceptable that any one of these items, any combination of these items, or a characteristic indicative of the other transmission performance are measured as the transmission performance information.

As one example of the BER measuring method, the BER measuring unit 47a retains a monitor bit string (for example, 10101010 . . . ) in advance and, in this state, the transmission side transmits a signal light, obtained by modulating a laser diode with the same monitor bit string, so that the BER measuring unit 47a makes a comparison between the bit string of the received signal light and the retained monitor bit string to count the number of errors.

Moreover, the Q-value measuring unit 47b is for measuring a Q-value. This Q-value is an index value for evaluation on the influence of an amplitude noise superimposed on an amplitude of a signal light. An example of the definition of the index value is an SN ratio obtained by calculating a BER at each point on an amplitude noise distribution curve which forms a Gaussian distribution and converting the minimum value of the calculated BERs.

The reception waveform measuring unit 47c is for measuring a waveform distortion. An example indicative of the magnitude of the waveform distortion is expressed as data obtained by making a comparison between a normal waveform data retained in advance and received waveform data and digitalizing the difference therebetween.

Moreover, the transmission performance information from the transmission performance information acquiring unit 47 is feedbacked to the transmission terminal node 200d through the use of an OSC light or up-direction WDM light (main signal light).

One example of control operation at this time is a method in which the wavelength control unit 33 previously retains a threshold of the transmission performance information relative to each channel and compares it with the transmission performance information of the corresponding channel measured or calculated and feedbacked and, when exceeding the threshold, carries out the wavelength control on the transmitter 10 of the corresponding channel and makes a comparison with the transmission performance information again feedbacked, thereby making the control for a wavelength whereby the transmission performance reaches the threshold.

In this connection, as other methods, for example, there are a method of adjusting the transmission wavelength so that the measured BER decreases, a method of adjusting the transmission wavelength so that the measured Q-value reaches a maximum, and a method of adjusting the transmission wavelength so that the received waveform becomes the best state or becomes equivalent to the design value.

With this arrangement and operation, the transmission performance information acquiring unit 47 of the reception terminal node 300d monitors or measures the respective transmission performance information such as BER, Q-value and waveform and transmits the transmission performance information through the use of the OSC light or the up-direction main signal light, so the wavelength control unit 33 of the transmission terminal node 200d acquires the transmission performance information through the OSC light receive 46b or the up-direction main signal light.

In addition, the wavelength control unit 33 changes the transmission wavelength of each channel so that the BER decreases, the Q-value increases or the received waveform becomes appropriate.

Thus, the WDM transmission system 100d achieves the dynamic automatic setting of a compensation quantity through the feedback control on the transmission performance information.

Still additionally, since the measurement and calculation of the transmission performance information can be made in operation, i.e., during the transmission of a main signal, it is possible that the transmission performance information is measured/calculated at all times, as needed, to carry out the wavelength control, or the transmission performance information is measured/calculated regularly or at any time to carry out the wavelength control, so that the residual dispersion quantity of each channel is maintainable in the optimum condition.

Incidentally, as the transmission performance information, in addition to the BER, an FER (Frame Error Rate), an SER (Symbol Error Rate) or the like are also employable.

(D3) Description of Third Modification of Third Embodiment of the Present invention

A third modification of the third embodiment of the present invention is such that a transmission performance (error correction frequency) is measured on the reception side and feedbacked to carry out the control each wavelength.

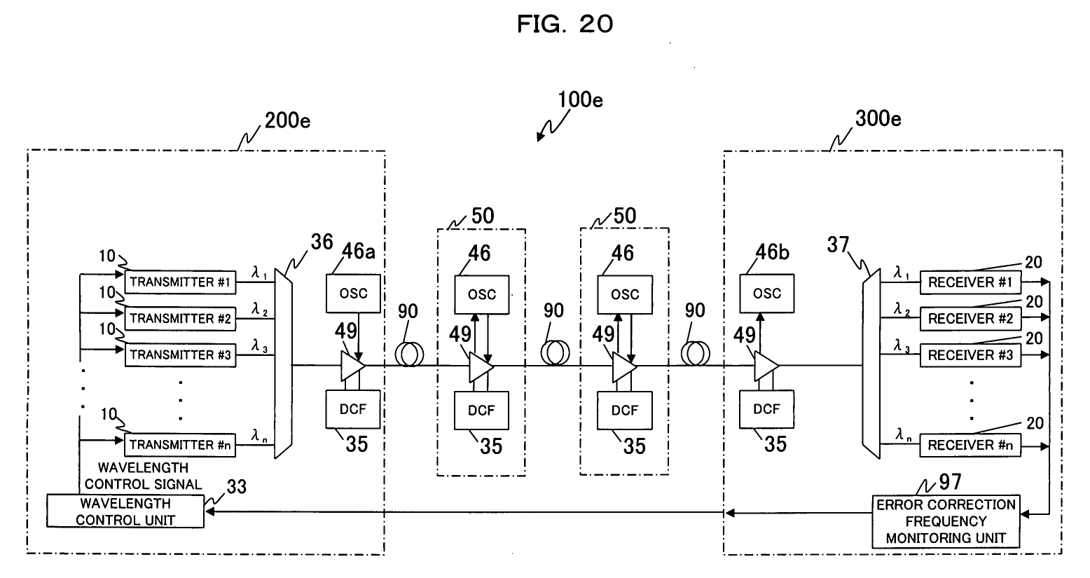

FIG. 20 is an illustration of a configuration of a WDM transmission system according to the third modification of the third embodiment of the present invention. A WDM transmission system 100e shown in FIG. 20 has a WDM light transmission function and a feedback control function for error correction frequency information on the FEC. In this configuration, a reception terminal node 300e is equipped with an error correction frequency monitoring unit (error correction frequency monitor) 97 for monitoring the number of times of error correction on the FEC, with the error correction frequency being monitored and feedbacked to the transmission side through an OSC light or a main signal. In this connection, it is also possible that the measured error correction frequency is feedbacked from the reception side to the transmission side through a monitor control apparatus (not shown) connected to the transmission terminal node 200e and the reception terminal node 300e.

In this configuration, the transmission terminal node 200e receives an error correction frequency from the reception terminal node 300e at every channel, and on the basis of the error correction frequency, the wavelength control unit 33 implements the transmission wavelength control for the transmitter 10 of the corresponding channel so that, for example, the error correction frequency for a given period of time becomes at a minimum.

In FIG. 20, the same reference numerals as those used above designate the same parts.

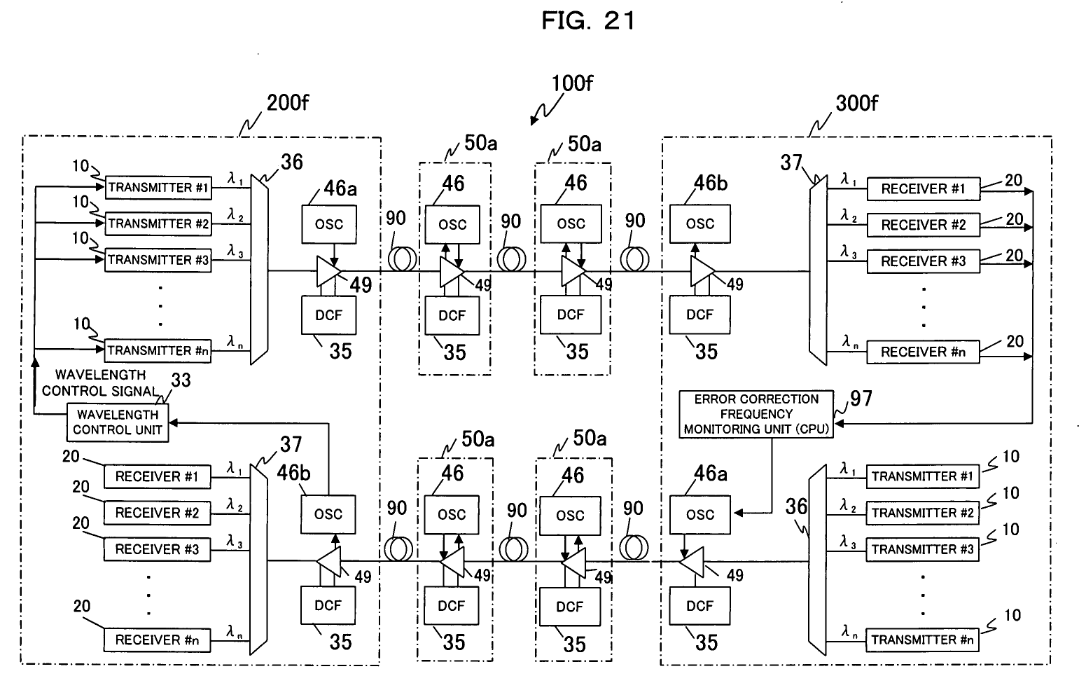

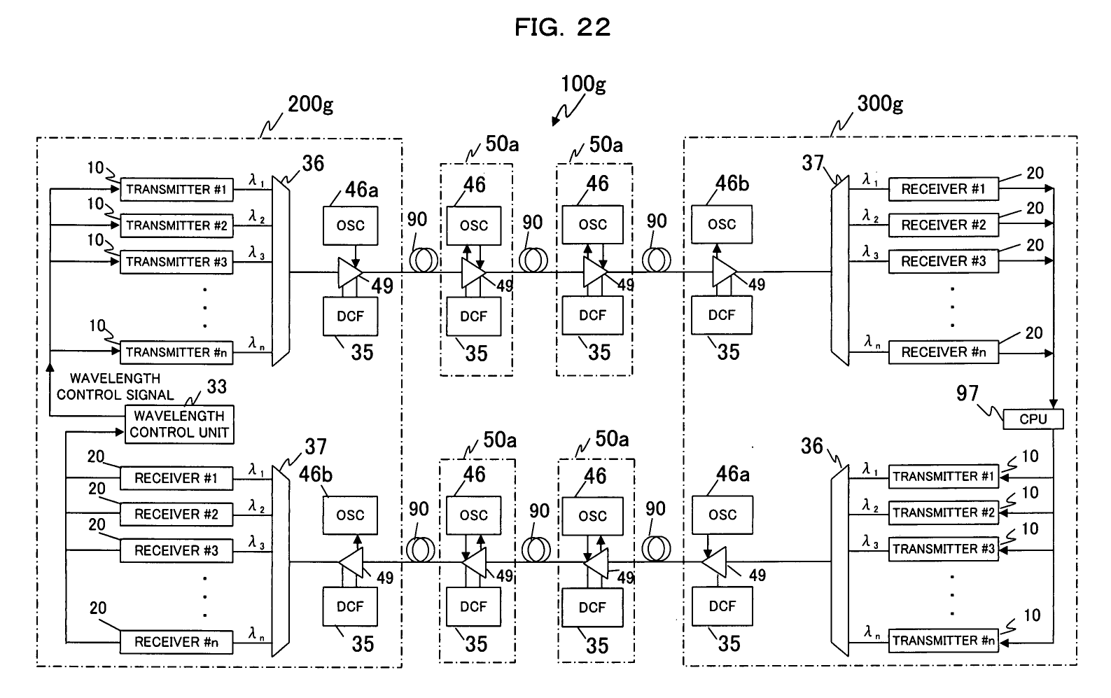

Referring to FIGS. 21 and 22, a description will be given hereinbelow of feedback control using an OSC light.

FIG. 21 is an illustration useful for explaining a feedback control configuration according to the third modification of the third embodiment of the present invention. A WDM transmission system 100f is made up of a transmission/reception terminal node 200f, a transmission/reception terminal node 300f, an inline amplifier 50a and optical transmission lines 90 for making connections therebetween.

An error correction frequency monitoring unit (CPU) 97 of the transmission/reception terminal node 300f collects the error correction frequencies in the receivers 20 #1 to #n corresponding to the respective channels (wavelengths λ₁ to λₙ) for a certain period of time. Moreover, the error correction frequency for each channel is transferred through an up-direction OSC light to a wavelength control unit 33 of the transmission/reception terminal node 200f, thus feedbacking the error correction frequency.

Meanwhile, FIG. 22 is an illustration useful for explaining another feedback control configuration according to the third modification of the third embodiment of the present invention. A WDM transmission system 100g is made up of a transmission/reception terminal node 200g, a transmission/reception terminal node 300g, an inline amplifier 50a and optical transmission lines 90 making connections therebetween.

An error correction frequency monitoring unit (CPU) 97 of the transmission/reception terminal node 300g collects error correction frequencies in the receivers 20 #1 to #n corresponding to the respective channels (wavelengths λ₁ to λₙ) for a certain period of time. Moreover, the error correction frequency for each channel is transferred through the transmitter 10 of the transmission/reception terminal node 300g and the receiver 20 of the transmission/reception terminal node 200g to a wavelength control unit 33 in a state included in an up-direction main signal, thus feedbacking the error correction frequency.

A detailed description will be given hereinbelow of, in this configuration, the transmission wavelength control based on the error correction frequency monitoring according to the third modification of the third embodiment of the present invention.

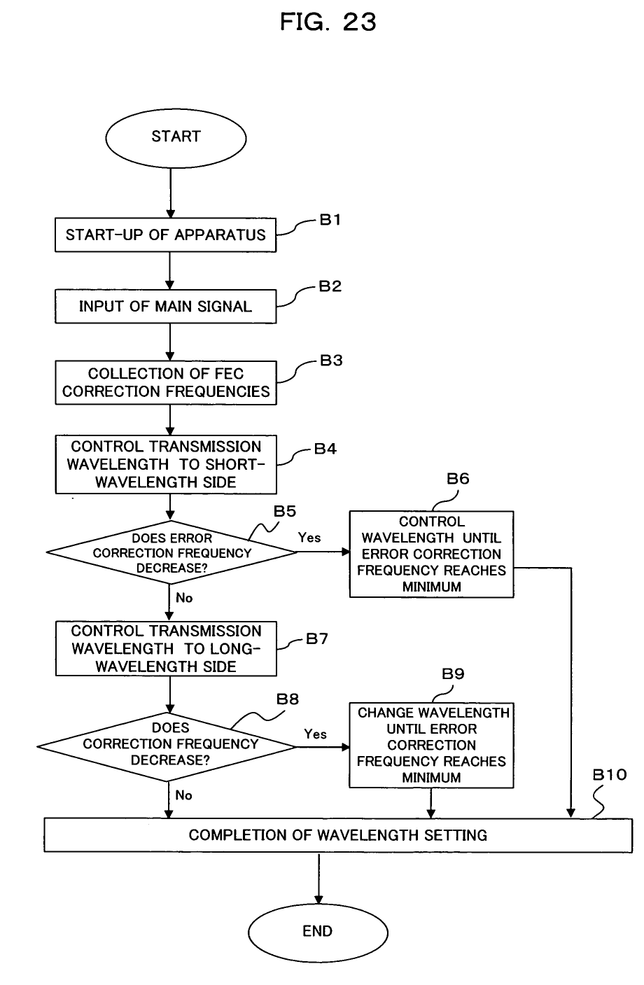

FIG. 23 is a flow chart useful for explaining the transmission wavelength control according to the third modification of the third embodiment of the present invention.

The following description is given of an operation with respect to one wavelength, for example λₖ, in the down-direction from the transmission/reception terminal node 200f (or 200g) to the transmission/reception terminal node 300f (or 300g).

The transmitting-side transmission/reception terminal node 200f (or 200g) is placed into activation (start-up of the apparatus) (step B1) and then starts the input of a main signal light (WDM light) (step B2). That is, the transmitter 10 #k is activated to start the output of the corresponding main signal.

On the other hand, the error correction frequency monitoring unit (CPU) 97 of the receiving-side transmission/reception terminal node 300f (or 300g) monitors the FEC error correction frequency with respect to a bit string, obtained by demodulating the main signal light received by the receiver 20 #k, and transmits this error correction frequency through the OSC light (or the main signal light) to the transmitting-side transmission/reception terminal node 200f (or 200g).

The wavelength control unit 33 of the transmission/reception terminal node 200f (or 200g) collects the error correction frequency corresponding to the received transmission wavelength λₖ through the use of a counter or the like, for example, for a predetermined period of time and retains it (step B3).

In this case, the wavelength control unit 33 carries out the control so that, for example, the transmission wavelength of the transmitter 10 #k is shifted by a certain quantity to the short-wavelength side (step B4). For example, the trigger for starting this transmission wavelength control takes place when the result of comparison between the received error correction frequency and an error correction frequency threshold previously set in the transmission/reception terminal node 200f (or 200g) shows that the received error correction frequency exceeds the threshold.

In addition, as the other starting triggers, there are a method of starting the wavelength control periodically and a method of starting the wavelength control in response to an instruction made by a maintainer as needed.

The wavelength control unit 33 of the transmission/reception terminal node 200f (or 200g) controls the wavelength of the transmitter 10 #k by a certain quantity toward the short-wavelength side and then continuously collects the error correction frequency from the transmission/reception terminal node 300f (or 300g) and makes a decision as to whether or not the error correction frequency decreases (step B5).

In a case in which the answer of the step B5 indicates a decrease in error correction frequency, the operational flow passes through the Yes route, and the wavelength control unit 33 controls the transmission wavelength to the short-wavelength side in stages until the error correction frequency reaches a minimum value (step B6) and brings the wavelength setting to an end at the time that the error correction frequency reaches the minimum value. Concretely, for example, the wavelength control unit 33 retains an error correction frequency at the wavelength control and a wavelength controlled variable in a state associated with each other and, since a variation in error correction frequency from a decrease to an increase signifies that the last stage but one takes the minimum value, the corresponding wavelength controlled variable is set in the transmitter 10 #k.

On the other hand, if the answer of the step B5 indicates no decrease in error correction frequency, the operational flow passes through the No route, and the wavelength control unit 33 controls the wavelength of the transmitter 10 #k by a certain quantity to the long-wavelength side (step B7) and continuously collects the error correction frequency from the transmission/reception terminal node 300f (or 300g) to make a decision as to whether or not the error correction frequency decreases (step B8).

If the answer of the step B8 indicates a decrease in error correction frequency, the operational flow goes to the Yes route, and the wavelength control unit 33 controls the transmission wavelength to the short-wavelength side in a stepwise fashion until the error correction frequency reaches a minimum value (step B9) and brings the wavelength setting to an end at the time that the error correction frequency takes the minimum value (step B10). On the other hand, if the answer of the step B8 indicates no decrease in error correction frequency, the operational flow proceeds through the No route and the wavelength setting comes to an end (step B10).

Thus, in the WDM transmission system 100f (or 100g), the dispersion compensation quantity varies in a manner such that the transmitting-side transmission/reception terminal node 200f (or 200g) monitors the error correction frequency in each channel in the receiving-side transmission/reception terminal node 300f (300g) to adjust/control the transmission wavelength of the corresponding transmitter 10 in each channel, which enables the individual transmission of a main signal at the optimum transmission quality (error correction frequency) for each channel.

In addition, the WDM transmission system 100f (or 100g) does not require the employment of a special transmission apparatus, a monitor line and others, and permits the optical fibers, DCFs 35 and others, already used, to be used without change, so the improvement of the transmission quality based on a change in dispersion compensation quantity is achievable through the use of a relatively simple configuration and an easy method.

As described above, according to the present invention, the function of a variable dispersion compensator is realized by a wavelength-variable function of the transmitter 10 and a dispersion characteristic of a dispersion compensating device (multiplexer 36 or demultiplexer 37, or both the multiplexer 36 and demultiplexer 37), and a high-transmission-quality WDM transmission system is realizable with the optimum residual dispersion by monitoring the transmission quality information (dispersion quantity, BER, Q-value, received waveform, reception error correction frequency) on the reception side and feedbacking it to the transmission side for carrying out the wavelength control.

(E) Description of Fourth Embodiment of the Present Invention

Differing from the application to the so-called point-to-point system, described in the above embodiments and modifications, in which the transmission end and reception end of each channel (wavelength) are the same places, the fourth embodiment relates to the application to a WDM transmission system in which an OADM node and others are provided in a transmission line 90 and the transmission end or the reception end, or both, are placed into a different condition according to channel (wavelength).

In the following description, the “path” signifies a transmission path from a transmission end to a reception end for the transmission at a certain wavelength.

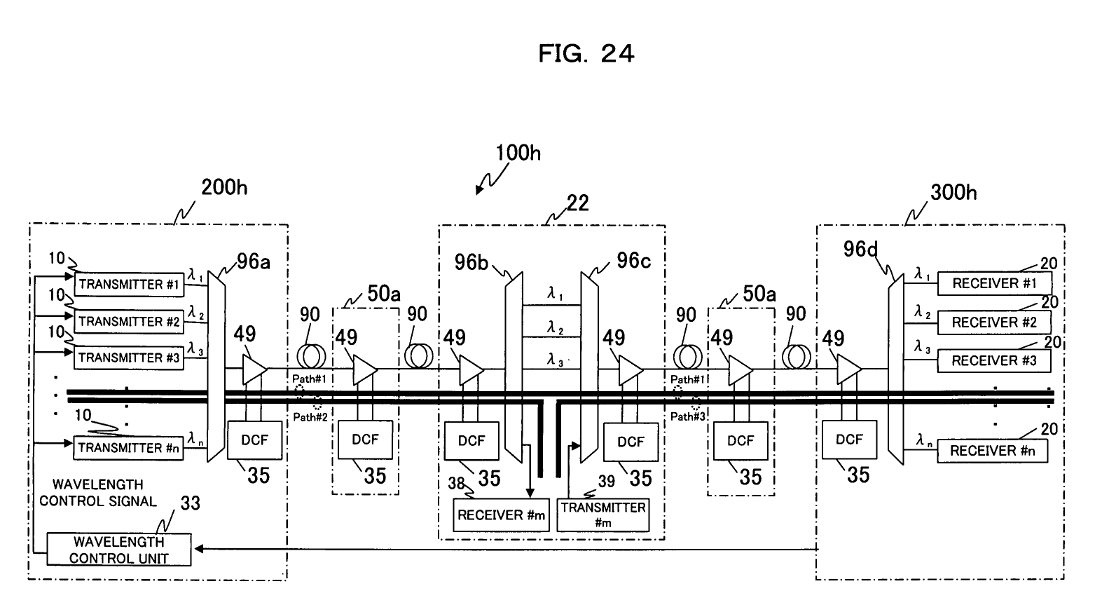

FIG. 24 is an illustration of a configuration of a WDM transmission system according to the fourth embodiment of the present invention. The WDM transmission system 100h has a WDM light transmission/reception function and an add/drop function and is made up of a transmission terminal node 200h having the almost same configuration as that of the transmission terminal node 200 (FIG. 10), a reception terminal node 300h having the almost same configuration as that of the reception terminal node 300 (FIG. 10), an OSDM node (optical add/drop apparatus) 22 having an add/drop function, an inline amplifier 50a, and optical transmission lines 90 for making connections therebetween.

In this configuration, the OADM node 22 has a function to demultiplex a WDM light from the transmission terminal node 200h for dropping (terminating a path) an optical signal of a portion of the channels (in FIG. 24, channel #m) and multiplexing the optical signals of the other channels together with an optical signal (in FIG. 24, channel #m) to be added and transmitting it to the reception terminal node 300h.

The OADM node 22 is composed of an amplifier 49, a DCF 35, a demultiplexer 96b, a multiplexer 96c, a receiver 38 and a transmitter 39.

In addition, the total dispersion characteristic of (i) a multiplexer 96a of the transmission terminal node 200h, (ii) the demultiplexer 96b of the OADM node 22, (iii) the multiplexer 96c of the OADM node 22 and (iv) a demultiplexer 96d of the reception terminal node 300h becomes the characteristic shown in FIG. 11B. In other words, the cooperation of the multiplexer 96a, the demultiplexer 96b, the multiplexer 96c and the demultiplexer 96d produces a function as the dispersion compensating device 1 (FIG. 6).

In FIG. 24, the same reference numerals as those used above designate the same components.

In the configuration shown in FIG. 24, of the WDM light received by the OADM node 22, a signal light of the path #2 is dropped to be inputted to the receiver 38 while, of the received WDM light, a signal light of the path #1 is multiplexed in the multiplexer 96c to be transmitted as the WDM light to the reception terminal node 300h. At this time, a signal light from the transmitter 39 of the OADM node 22 is added to the WDM light in the multiplexer 96c to be transmitted as a signal light of the path #3.

In this case, the paths #1 to #3 are different in optimum residual dispersion quantity from each other because of differences in transmission condition such as transmission distance, number of spans and transit node.

Accordingly, although there is a need to appropriately adjust the dispersion compensation quantity according to path, for example, if a DCF having a fixed dispersion compensation quantity is put to use, difficulty is experienced in setting an appropriate dispersion compensation quantity.

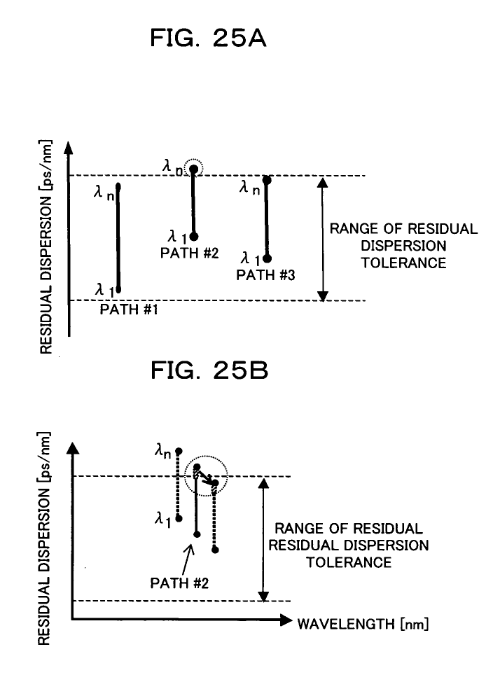

Referring to FIGS. 25A and 25B, a detailed description will be given hereinbelow of the effects of a system design to which the present invention is applied for adjusting the dispersion compensation quantity.

FIG. 25A is an illustration indicative of whether or not the WDM light channels (λ₁ to λₙ) are in a range of a residual dispersion tolerance (a tolerance range of a residual dispersion) with respect to the paths #1 to #3.

In the WDM system 100h, it is preferable that all the channels constituting the WDM light can be transmitted through any path #1 to #3.

However, since, with reference to the longest path #1 strictest in transmission condition, the dispersion compensation quantity of a DCF or the location thereof is designed so as to achieve the optimum dispersion compensation, there is a case in which difficulty is encountered in providing the optimum dispersion compensation for the paths #2 and #3.

For example, in an example shown in FIG. 25A, in the channel n (λₙ) of the path #2, the residual dispersion is out of the tolerance, and the channel n (according to circumstances, including the peripheral channels) cannot be applied to the path #2, which can affect the system design.

FIG. 25B is an illustration for explaining the effects in the case of the employment of the residual dispersion adjusting method according to the fourth embodiment of the present invention.

In the case of the employment of the present invention, since the independent function of a variable dispersion compensator for each channel is realizable by means of the wavelength variable function of the transmitter 39 and the dispersion characteristic of the dispersion compensating device (multiplexer 96a, demultiplexer 96b, multiplexer 96c, demultiplexer 96d), as shown in FIG. 25B, the residual dispersion of the channel n can be set in the tolerance, and all the channels are applicable with respect to all the paths. In other words, the relaxation of the restrictions on the dispersion compensation at the system design is achievable by the variable dispersion function.

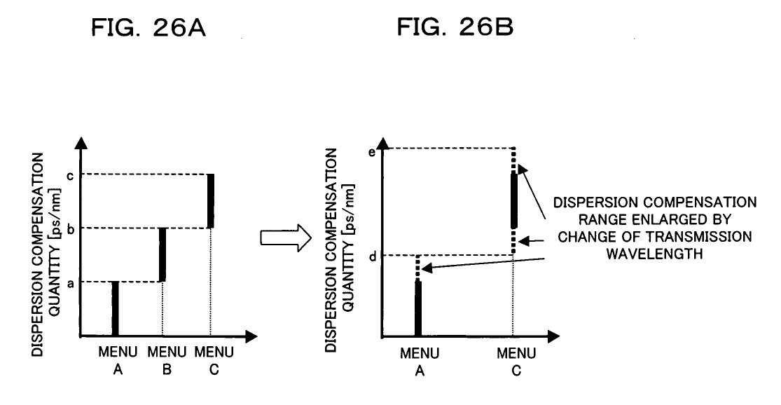

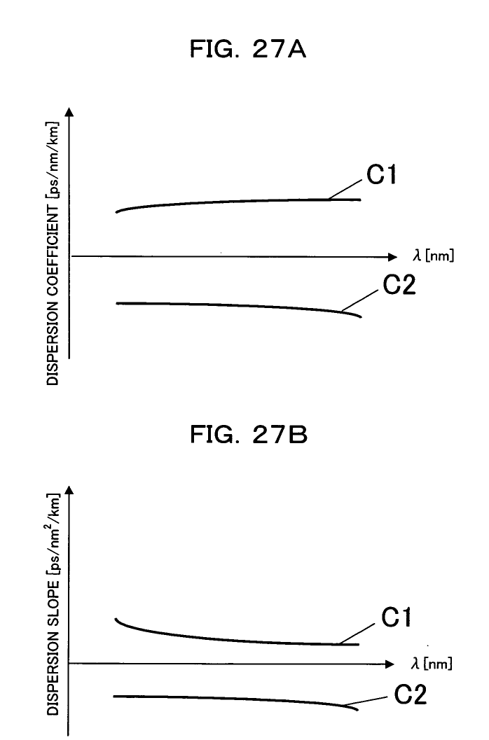

In addition, referring to FIGS. 26A and 26B, a description will be given hereinbelow of the other effects of the system design in the case of the employment of the present invention.

FIG. 26A is an illustration of one example of a conventional dispersion compensator menu.

In FIG. 26A, the dispersion compensator menus A, B and C correspond to, for example, types of DCF, respectively, and have dispersion compensation quantities (see the vertical axis) in a certain range according to length. For example, the dispersion compensation quantities are such that menu A: 0 to −100 ps/nm, menu B: −100 to −200 ps/nm and menu C: −200 to −300 ps/nm.

For the system design, a DCF selected from these three types of menus is used for obtaining a needed dispersion compensation quantity.

In the case of the employment of the present invention, since the function of a variable dispersion compensator is realized by means of the wavelength variable functions of the transmitters 10 and 39 and the dispersion characteristic of the dispersion compensating device, the menus can be made in consideration of this realization.

That is, as shown in FIG. 26B, the examination of the system design can be made in a state where a variable dispersion compensation quantity (indicated by a dotted line) is added to a dispersion compensation quantity (indicated by a solid line) a DCF possesses originally, and in this example, a menu corresponding to the menu B is reducible.

In other words, the dispersion compensation ranges of the dispersion compensator menus A and C shown in FIG. 26B are enlargeable.

This can eliminate the need for preparing a large number of dispersion compensator menu according to the type of transmission line and the transmission distance (dispersion).

(F) Others

It should be understood that the present invention is not limited to the above-described embodiments, and that it is intended to cover all changes and modifications of the embodiments of the invention herein which do not constitute departures from the spirit and scope of the invention.

Although, since the transmission condition such as transmission distance varies for each path in the case of the employment of a different network shape such as hub type or ring type, difficulty has so far experienced in carrying out an appropriate dispersion compensation, the present invention enables an appropriate dispersion compensation for each path.

In addition, various types can be used as enable signal formats and others.

1. An optical transmission apparatus for use in an optical transmission system, comprising:
a dispersion compensating device having a wavelength-dependency dispersion characteristic for compensating for dispersion of transmitted light; and
a wavelength-variable transmission unit for transmitting light whose center emission wavelength is shifted by a wavelength fluctuation quantity relative to said dispersion characteristic of said dispersion compensating device.

2. The optical transmission apparatus according to claim 1, wherein said transmission unit is made to vary a wavelength of single-wavelength light on the basis of a dispersion slope of said dispersion compensating device.

3. The optical transmission apparatus according to claim 1, further comprising a wavelength control unit for controlling said wavelength fluctuation quantity on the basis of wavelength control information relative to a dispersion quantity acquired on a reception side.

4. The optical transmission apparatus according to claim 3, wherein said wavelength control unit is made to control said wavelength fluctuation quantity on the basis of said wavelength control information feedbacked through a transmission line of said optical transmission system.

5. The optical transmission apparatus according to claim 1, wherein said wavelength control unit is made to control said wavelength fluctuation quantity on the basis of an actual dispersion quantity of a transmission line of said optical transmission system.

6. The optical transmission apparatus according to claim 1, wherein said wavelength control unit is made to control said wavelength fluctuation quantity on the basis of transmission performance information from a monitor unit made to acquire information on a transmission performance of said optical transmission system.

7. The optical transmission apparatus according to claim 1, wherein said transmission unit is made to output single-wavelength light having a wavelength obtained by shifting the shortest wavelength in a wavelength-multiplexed light transmission band to a long-wavelength side and further to transmit single-wavelength light having a wavelength obtained by shifting the longest wavelength in said wavelength-multiplexed light transmission band to a short-wavelength side.

8. The optical transmission apparatus according to claim 1, wherein said dispersion compensating device is designed as a demultiplexing unit made to demultiplex wavelength-multiplexed light.

9. The optical transmission apparatus according to claim 1, wherein said dispersion compensating device is designed as a multiplexer made to multiplex a plurality of single-wavelength lights.

10. The optical transmission apparatus according to claim 1, wherein said dispersion compensating device is made by a combination of a demultiplexing unit for demultiplexing wavelength-multiplexed light and a multiplexer for multiplexing a plurality of single-wavelength lights.

11. An optical transmission apparatus comprising:
a plurality of transmission units different in center emission wavelength from each other;
a dispersion compensating device having a dispersion characteristic which develops repeatedly with respect to a wavelength in a predetermined wavelength band; and
a wavelength control unit for controlling the center emission wavelengths of said transmission units on the basis of transmission performance information measured on a reception side.

12. An optical transmission system including a plurality of optical transmission apparatus, comprising:
a dispersion compensating device having a wavelength-dependency dispersion characteristic for compensating for dispersion of transmitted light; and
a wavelength-variable transmitting-side optical transmission unit for transmitting a single-wavelength light having a wavelength shifted by a wavelength fluctuation quantity relative to a dispersion characteristic of said dispersion compensating device.

13. The optical transmission system according to claim 12, wherein said transmitting-side optical transmission unit includes a wavelength-variable transmission unit for outputting one of a plurality of single-wavelength lights different in wavelength from each other.

14. The optical transmission system according to claim 13, further comprising a wavelength control unit for controlling said wavelength fluctuation quantity on the basis of wavelength control information relative to a dispersion quantity acquired in one of said plurality of optical transmission apparatus.

15. The optical transmission system according to claim 14, wherein said wavelength control unit receives at least one of dispersion quantity information and transmission performance information included in said wavelength control information through the use of one of sub-signal light transmitted from a reception side to a transmission side, monitor control means for monitoring and controlling said plurality of optical transmission apparatus and main signal light transmitted from said reception side to said transmission side.

16. The optical transmission system according to claim 12, wherein said dispersion compensating device has a total dispersion characteristic based on a dispersion characteristic of a multiplexer or a demultiplexer provided in a transmission line.

17. The optical transmission apparatus according to claim 11, wherein dispersion compensation is made through the use of a plurality of dispersion compensator menus in which a dispersion compensation quantity relative to a wavelength fluctuation quantity in said transmission unit and said dispersion compensating device are associated with each other.

18. A dispersion compensating method for use in an optical transmission system including a plurality of optical transmission apparatus having a transmitting-side optical transmission unit and a receiving-side optical transmission unit, comprising:
a dispersion quantity acquiring step in which said receiving-side optical transmission unit acquires a dispersion quantity with respect to first single-wavelength light outputted from a wavelength-variable transmission unit provided in said transmitting-side optical transmission unit for outputting single-wavelength light;
a transmission step in which said receiving-side optical transmission unit transmits, to said transmitting-side optical transmission unit, wavelength control information relative to said dispersion quantity acquired in said dispersion quantity acquiring step; and
a fluctuation step in which said transmitting-side optical transmission unit fluctuates a wavelength of said transmission unit on the basis of said wavelength control information transmitted in said transmission step.

19. The dispersion compensating method according to claim 18, wherein, in said transmission step, said receiving-side optical transmission unit transmits said wavelength control information including at least one of dispersion quantity information and transmission performance information to said transmitting-side optical transmission unit.
